(19) United States
(12) Patent Application Publication
(10) Pub. No.: US 2008/0123750 A1
(43) Pub. Date: May 29, 2008

(54) Parallel deblocking filter for H.264 video codec

(76) Inventors: Michael Bronstein, Haifa (IL); Alexander Bronstein, Haifa (IL); Ron Kimmel, Haifa (IL); Selim Shlomo Rakib, Cupertino, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/605,946

(22) Filed: Nov. 29, 2006

(51) Int. Cl. H04N 7/18

(52) U.S. Cl. 375/240.24

(57) ABSTRACT

A process and apparatus for implementing parallelization in deblocking filter used in a an H.264 codec are disclosed. In the preferred embodiment, the process is carried out on a parallel architecture consisting of a plurality of groups, each consisting of eight clusters, wherein each cluster is a separate processor capable of tensor operations in SIMD or MIMD or mode on 4×4 matrix data. All eight clusters of one group are used to simultaneously deblock both luma and chroma vertical and horizontal edges between 4×4 blocks of pixels in a macroblock in a total of eight iterations, utilizing in the best way the data dependency between the edges. Processes to deblock these same luma and chroma edges in more iterations on four cluster and two cluster parallel architectures are also disclosed. A comparison of the maximum parallelization achievable with the invention and the amount of parallelization with various species within the prior art is also disclosed.

### BACKGROUND OF THE INVENTION

Digital video such as DirecTV and DVD applications has been growing in popularity. Digitizing a video signal generates huge amounts of data. Frames of pixels are generated many times per second, and each frame has many pixels. Each pixel has a plurality of bits which defines it luminance (brightness) and two different sets of bits which define its color.

A digital video signal is often represented in a YCbCr format, which follows the human visual perception model. Y is the luminance (or luma) information and Cb and Cr is the chrominance (or chroma) information. The human eye is most sensitive to the luminance information as that is where the detail of edges is found; the chrominance information plays less importance. For this reason, Cb and Cr channels are often subsampled as by a factor of 2 in the horizontal and vertical dimensions in order to save on the representation. Such a format is referred to as YCbCr 4:2:0.

The huge amount of data involved in representing a video signal cannot be transmitted or stored practically because of the sheer volume and limitations on channel bandwidth and media storage capacity; compression is therefore necessary. Because a video has high spatial and temporal redundancy (the first relating to the fact that neighbor pixels within a frame are similar, and the second relating to the fact that two subsequent frames are similar), getting rid of such redundancy is the basis of modern video compression approaches. Compression generally speaking tries to predict a frame from the previous frames exploiting temporal redundancy, and tries to predict parts of a frame from other parts of the same frame exploiting spatial redundancy. Only the difference information is transmitted or stored. MPEG2 and MPEG4 are examples of compression which are familiar today.

In the last few years, High Definition (HD) television formats have been gaining popularity. HD complicates the data volume problem because HD formats use even more pixels than the standard NTSC signals most people are familiar with.

The H.264 Advanced Video Codec (AVC) is the most recent standard in video compression. This standard was developed by the Joint Video Team of ITU-T and MPEG groups. It offers significantly better compression rate and quality compared to MPEG2/MPEG4. The development of this standard has occurred simultaneously with the proliferation of HD content. The H.264 standard is very computationally intensive. This computational intensity and the large frame size of HD format signals pose great challenges for real-time implementation of the H.264 codec.

To date some attempts have been made in the prior art to implement H.264 codecs on general purpose sequential processors. For example, Nokia, Apple Computer and Ateme have all attempted implementations of the H.264 standard in software on general purpose sequential computation computers or embedded systems using Digital Signal Processors. Currently, none of these systems is capable of performing real time H.264 encoding in full HD resolutions.

Parallel general purpose architectures such as Digital Signal Processors (DSPs) have been considered in the prior art for speeding up computationally-intensive components of the H.264 code. For example, DSPs were used for the motion estimation and deblocking processes in papers by H. Li et al., Accelerated Motion Estimation of H.264 on Imagine Stream Processor, Proceedings of ICIAR, p. 367-374 (2005) and J. Sankaran, Loop Deblocking of Block Coded Video in a Very Long Instruction Word Processor, U.S. Patent Application Publication 20050117653, (June 2005 Texas Instruments). DSPs are well adapted for performing one dimensional filtering, but they lack the capability of processing two-dimensional data as required in digital video processing and coding applications.

There also exist in the prior art hardware implementations custom tailored for H.264 codecs including chips by Broadcom, Conexant, Texas Instruments and Sigma Designs. Special architectures were proposed for some computationally-intensive components of the H.264 codec. There follows some examples.

1) Intra-prediction schemes are taught by Drezner, D, Advanced Video Coding Intra Prediction Scheme, U.S. Patent Application 20050276326 (December 2005 Broadcom), and Dottani et al., Intra 4×4 Modes 3, 7 and 8 Availability Determination Intra Estimation and Compensation, U.S. Pat. No. 7,010,044 (March 2006 LSI Logic);

2) Inverse transform and prediction in a pipelined architecture is taught in Luczak et al., A Flexible Architecture for Image Reconstruction in H.264/AVC Decoders, Proceedings ECCTD (2005). This paper presents a pipelined architecture to do image reconstruction using bit serial algorithms on a pipeline using an intra 4×4 predictor architecture, adder grid and plane predictor and a 1-D inverse transformation engine of FIG. 4 using serial arithmetic with the reconstruction block including one or up to four 4×4 modules, each of which performs intra-prediction, inverse quantization and transformation with possible arrangements shown in FIG. 6 with the output of one stage being an input to the next pipeline stage so this is not a true parallel processing implementation, but it does save clock cycles.

3) Video data structures are taught by Linzer et al., 2-D Luma and Chroma DMA Optimized for 4 Memory Banks, U.S. Pat. No. 7,015,918 (March 2006 LSI Logic).

4) Basic operations such as scan conversion are taught by Mimar, Fast and Flexible Scan Conversion and Matrix Transpose in SIMD Processor, U.S. Pat. No. 6,963,341 (November 2005).

For the in-loop deblocking filter in the H.264 standard, several special architectures were proposed:

1) V. Venkatraman et al., Architecture for Deblocking Filter in H.264, Proceedings Picture Coding Symposium (2004). proposed a hardware accelerator which is optimized for H.264 deblocking computations and requires a general purpose processor and addition components to implement the entire codec.

2) A pipelined deblocking filter is taught by Kim, Y.-K et al., Pipeline Deblocking Filter, U.S. Patent Application Publication 20060115002 (June 2006 Samsumg Electronics).

3) Parallel processing of the deblocking filter is taught by Dang, P. P., Method and Apparatus for Parallel Processing of In-Loop Deblocking Filter for H.264 Video Compression Standard, U.S. Patent Application Publication 20060078052 (December 2005)

4) J. Li, Deblocking filter process with local buffers, U.S. Patent Application 20060029288 (February 2006) teach a memory buffer architecture for deblocking filter.

### Other Prior Art Hardware Implementations of H.264 Video Codecs

Several companies are mass-producing custom chips capable of decoding H.264/AVC video. Chips capable of real-time decoding at high-definition picture resolutions include these:
Broadcom BCM7411
Conexant CX2418X
Sigma Designs SMP8630, EM8622L, and EM8624L
STMicroelectronics STB7100, STB7109, NOMADIK (STn 8800/8810/8815 series)
WISchip (now Micronas USA, Inc.) DeCypher 8100
Motorola (now Freescale Semiconductor, Inc.) i.m×31
Texas Instruments TMS320DM642 DSP and TMS320DM644x DSPs based on DaVinci Technology

Such chips will allow widespread deployment of low-cost devices capable of playing H.264/AVC video at standard-definition and high-definition television resolutions.

Many other hardware implementations are deployed in various markets, ranging from inexpensive consumer electronics to real-time FPGA-based encoders for broadcast. A few of the more familiar hardware product offerings for H.264/AVC include these:
ATI Technologies' newest graphics processing unit (GPU), the Radeon X1000-series, features hardware acceleration of H.264 decoding starting in the Catalyst 5.13 drivers. H.264 decoding is one component of the ATI “AVIVO” multimedia technology
NVIDIA has released drivers for hardware H.264 decoding on its GeForce 7 Series and some GeForce 6 Series GPUs. A supported cards list can be found at NVidia's PureVideo page.
Apple added H.264 video playback to their 5th Generation iPod on Oct. 12, 2005. The new product uses this format, as well as MPEG-4 Part 2, for video playback. The video-enabled iPod uses the H.264 Baseline Profile with support of bit rates up to 768 kbit/s, image resolutions up to 320×240, and frame rates up to 30 frames per second.
WorldGate sells the Ojo videophone (formerly distributed by Motorola), which uses H.264 Baseline Profile at QCIF (144×176) image resolution with bitrates of 80 to 500 kbit/s, at a fixed framerate of 30 frames per second.
HaiVision developed the hai200 TASMAN and hai1000, used predominantly in low latency applications including telepresence (collaboration suites) and medical (remote surgery), SD resolution at up to 6 Mbit/s.
Mobilygen develops MG1264 Low Power H.264/AAC Codec For Mobile Products. The MG1264 is a complete H.264/AAC AV codec capable of TV quality D1/VGA video and high-fidelity 2-channel audio. Requiring only 185 mw for encoding full video resolution, and stereo audio, the MG1264 is ideally suited for battery powered mobile products, as well as traditional “plugged in” products.
USDTV is now using this codec for over-the-air “cable” TV network channels on ATSC. Appearing as subchannels on DTV virtual channel 99, these are normally viewable only on special set-top boxes. Originally using WMV9, special USB upgrades were sent to earlier box owners. Because UpdateTV will come installed on most ATSC tuners (beginning 2007 model year), there is a significant chance that this codec could later become an ATSC-accepted standard for non-subscription broadcasts from TV stations. This is because UpdateTV would we able to distribute the new codec through datacasting.

There still does exist however a need for a highly parallel architecture and processes for using the data independency of macroblocks in video frames in highly parallel computer architectures which are adapted to efficiently do operations on two dimensional signals expressed in the form of 4×4 matrices of integers which can be used both for H.264 compression and other compression standards such as MPEG2/MPEG4 etc.

### BRIEF DESCRIPTION OF THE DRAWINGS

FIG. 1, there is shown a block diagram of a prior art video data encoder to compress raw video pixel luminance data down to a smaller size.

FIG. 2 is a block diagram of the decoder circuitry which decompresses the received compressed signal on line 38 and outputs the reconstructed frame on line 42.

FIG. 3 is a block diagram of the H.264 prior art video compression encoder.

FIG. 4 illustrates the luma and chroma pixels required for and processed during the deblocking of a macroblock, and the numbering convention thereof. This convention will be used to illustrate the parallelization of the deblocking process in prior art and in the current invention.

FIG. 5, comprised of FIGS. 5A, 5B, 5C, 5D and 5E, shows, in FIGS. 5A through 5D, respectively, the order of luma and chroma vertical and horizontal edge deblocking in prior art parallel deblocking filters according to Y.-W. Huang et al. (100A), V. Venkatraman et al. (100B), Y.-K. Kim et al. (100C), P. P. Dang (100D). FIG. 5E show the order of luma and chroma vertical and edge processing according to the most preferred embodiment of the current invention wherein maximum efficiency and parallelization is achieved. Numbers denote the iteration at which the edge is processed.

FIG. 6, comprised of FIGS. 6A and 6B, depicting a flow diagram of luma (FIG. 6A) and chroma Cb or Cr (FIG. 6B) deblocking process according to an embodiment of the current invention, including independent vertical 500 and horizontal 502 edge filter units. The inputs to the filters are 4×4 blocks of a macroblock in accordance with the edge numbering convention in FIG. 4, and the outputs are the corresponding filtered 4×4 blocks.

FIG. 7 is a flow diagram of the vertical luma or chroma edge deblocking filter unit 500, comprising long filter 600, short filter 602 and a selector thereof 604.

FIG. 8 is a schematic representation of a horizontal luma or chroma edge filter 502, obtained from vertical luma or chroma edge filter 500 and pixel transposition units 700.

FIG. 9, comprised of FIGS. 9A, 9B and 9C, is an exemplary highly parallel processing architecture, referred to as AVIOR (FIG. 9A), including four groups (FIG. 9B), each containing eight clusters (FIG. 9C), each containing a parallel tensor processor.

FIG. 10 is a diagram illustrating one possibility of obtaining the maximum parallelization of luma and chroma deblocking using an AVIOR or other parallel architecture with 8 clusters, and illustrating the sets of luma and chroma edges and the order in which they are deblocked, in the corresponding sets of iterations.

FIGS. 11A and 11B are a diagram illustrating a possible parallelization of luma and chroma edge deblocking on the AVIOR architecture with 4 clusters. FIG. 11A illustrates the luma edges deblocked during the first 8 iterations, and FIG. 11B illustrates the chroma edges deblocked during the last four iterations. FIG. 12 is a diagram illustrating one possibility of obtaining the maximum parallelization of luma and chroma deblocking using an AVIOR or other parallel architecture with 2 clusters, and illustrating the sets of luma and chroma edges and the order in which they are deblocked, in the corresponding sets of iterations.

FIG. 13, comprised of FIGS. 13A and 13B, is an example two 4×4 blocks of pixels 342, 344 adjacent to a vertical edge 340 (A) used as an input to the vertical edge filter 500 and two 4×4 blocks of pixels 343, 345 adjacent to a horizontal edge 341 (B), used as an input to the horizontal edge filter 502.

### SUMMARY OF THE INVENTION

The present invention is a method and apparatus to perform deblocking filtering on any parallel processing platform to speed it up. The general notion here is to speed up the deblocking process by dividing the problem up into sub-problems which are data independent of each other such that each sub-problem can be solved on a separate computational path in any parallel processing architecture.

The genus of the invention is defined by the following characteristics which all species within the genus will share:

1) simultaneous deblocking of vertical luma edges during at least some of a plurality of iterations on at least some of a plurality of computational units of a parallel processing architecture computer, and simultaneous deblocking of both vertical and horizontal luma edges during at least some of a plurality of iterations on at least some of a plurality of computational units of a parallel processing architecture computer;

2) the order of deblocking of both horizontal and vertical edges is determined by both raster scan order and data dependency;

3) if there are enough computational units available such that some are idle during some iterations, then idle computational units are used to deblock vertical and/or horizontal chroma channel edges simultaneously with deblocking of vertical and/or horizontal luma edges or simultaneous deblocking of multiple vertical chroma edges alone during at least some of a plurality of iterations on at least some of a plurality of computational units of a parallel processing architecture computer and simultaneous deblocking of multiple horizontal chroma edges alone during at least some of a plurality of iterations on at least some of a plurality of computational units of a parallel processing architecture computer, wherein the order of deblocking of chroma vertical and horizontal edges is determined by raster scan order and data dependency, and wherein whether or not simultaneous deblocking of luma and chroma edges occurs on some of said plurality of edges depends upon the number of computational units available;

4) simultaneous filtering of several lines of pixels in the blocks for deblocking of each edge

In the preferred class of embodiments the luma and chroma edges are divided into six sets. The vertical luma edges form the first set of edges. The horizontal luma edges form the second set of edges. The vertical Cb chroma edges form the fourth set of edges, the vertical Cr chroma edges form the fifth set of edges, and the horizontal Cb chroma edges form the sixth set of edges. The processing of each of these sets of edges is carried out on a plurality of computational units referred to herein as clusters, in a set of iterations determined by the data dependency between a set of edges and other sets of edges. The processing is carried out such the first set of edges is deblocked by a first set of clusters in a first set of iterations, and so on for the rest of the sets of edge, mutatis mutandis. During this processing, the set of clusters and set of iterations may be partially or completely overlapping or completely disjoint depending upon the number of clusters available. Overlap of sets of iterations implies simultaneous processing of parts or entire sets of edges. Overlap of sets of clusters implies that processing of different parts of sets of edges is allocated to the same computational units.

### The Basics of Digital Video Compression

Digital video is a type of video recording system that works by using a digital, rather than analog, representation of the video signal. This generic term is not to be confused with DV, which is a specific type of digital video. Digital video is most often recorded on tape, then distributed on optical discs, usually DVDs.

Video compression refers to making a digital video signal use less data, without noticeably reducing the quality of the picture. In broadcast engineering, digital television (DVB, ATSC and ISDB) is made practical by video compression. TV stations can broadcast not only HDTV, but multiple virtual channels on the same physical channel as well. It also conserves precious bandwidth on the radio spectrum. Nearly all digital video broadcast today uses the MPEG-2 standard video compression format, although H.264/MPEG-4 AVC and VC-1 are emerging contenders in that domain.

MPEG-2 is the designation for a group of coding and compression standards for Audio and Video (AV), agreed upon by MPEG (Moving Picture Experts Group), and published as the ISO/IEC 13818 international standard. MPEG-2 is typically used to encode audio and video for broadcast signals, including direct broadcast satellite (DirecTV or Dish Network) and Cable TV. MPEG-2, with some modifications, is also the coding format used by standard commercial DVD movies.

H.264, MPEG-4 Part 10, or AVC, for Advanced Video Coding, is a digital video codec standard which is noted for achieving very high compression ratios. A video codec is a device or software module that enables video compression or decompression for digital video. The compression usually employs lossy data compression. In daily life, digital video codecs are found in DVD (MPEG-2), VCD (MPEG-1), in emerging satellite and terrestrial broadcast systems, and on the Internet.

The H.264 standard was written by the ITU-T Video Coding Experts Group (VCEG) together with the ISO/IEC Moving Picture Experts Group (MPEG) as the product of a collective partnership effort known as the Joint Video Team (JVT). The ITU-T H.264 standard and the ISO/IEC MPEG-4 Part 10 standard (formally, ISO/IEC 14496-10) are technically identical. The final drafting work on the first version of the standard was completed in May of 2003.

The need for video compression stems from the fact that digital video always requires high data rates—the better the picture, the more data is needed. This means powerful hardware, and high bandwidth when video is transmitted. However, much of the data in video is either redundant or easily predicted—for example, successive frames in a movie rarely change much from one to the next—this makes data compression work well with video. Such compression is referred to as lossy, because the video that can be recovered after such a process is not identical to the original one.

In computer science and information theory, data compression or source coding is defined as the process of encoding information using fewer bits (or other information-bearing units) than a raw (prior to coding) representation would use. The forward process of creating such a representation is termed encoding, the backward process of recovering the information is termed decoding. The entire scheme comprising an encoder and decoder is called a codec, for coder/decoder.

If the original data can be recovered precisely by the decoder, such a compression is termed lossless. Video compression can usually make video data far smaller while permitting a little loss in quality. For example, DVDs use the MPEG-2 compression standard that makes the movie 15 to 30 times smaller, while the quality degradation is not significant.

Video is basically a three-dimensional array of color pixels. Two dimensions serve as spatial (horizontal and vertical) directions of the moving pictures, and one dimension represents the time domain. A frame is a set of all pixels that correspond to a single point in time. Basically, a frame can be thought of as an instantaneous still picture.

Video data is often spatially and temporally redundant. This redundancy is the basis of modern video compression methods. One of the most powerful techniques for compressing video is inter-frame prediction. In the MPEG and H.264 video compression lexicon, this is called P mode compression. Each frame is divided into blocks of pixels, and for each block, the most similar block is found in adjacent reference frame by a process called motion estimation. Due to temporal redundancy, the blocks will be very similar, therefore, one can transmit only the difference between them. The difference, called residual macroblock, undergoes the process of transform coding and quantization, similarly to JPEG. Since inter-frame relies on previous frames, by loosing part of the encoded data, successive frames cannot be reconstructed. Also, prediction errors to be accumulated, especially if the video content changes abruptly (e.g. at scene cuts). To avoid this problem, I frames are in MPEG compression. I frames are basically treated as JPEG compressed pictures.

Compression of residual macroblocks and the blocks in I frames is based on the discrete cosine transform (DCT), whose main aim is spatial redundancy reduction. The discrete cosine transform (DCT) is a Fourier-type transform similar to the discrete Fourier transform (DFT), but using only real numbers. It is equivalent to a DFT of roughly twice the length, operating on real data with even symmetry (since the Fourier transform of a real and even function is real and even), where in some variants the input and/or output data are shifted by half a sample. (There are eight standard variants, of which four are common.) The most common variant of discrete cosine transform is the type-II DCT, which is often called simply “the DCT”; its inverse, the type-III DCT, is correspondingly often called simply “the inverse DCT” or “the IDCT”.

Two related transforms are the discrete sine transform (DST), which is equivalent to a DFT of real and odd functions, and the modified discrete cosine transform (MDCT), which is based on a DCT of overlapping data.

The H.264 video compression standard requires that a Modified Integer Discrete Cosine Transfer be used, and its particular implementation with integer arithmetic, and that is what is used in the preferred embodiments of H.264 video codec implementations according to the teachings of the invention doing compression. However, the term “Discrete Cosine Transform” if used in the claims, should be interpreted to cover the DCT and all its variants that work on integers.

Further compression is achieved by quantization. In digital signal processing, quantization is the process of approximating a continuous or very wide range of values (or a very large set of possible discrete values) by a relatively small set of discrete symbols or integer values. Basically, it is truncation of bits and keeping only a selected number of the most significant bits. As such, it causes losses. The number of bits kept is programmable in most embodiments but can be fixed in some embodiments.

The quantization can either be scalar quantization or vector quantization; however, nearly all practical designs use scalar quantization because of its greater simplicity. Quantization plays a major part in lossy data compression. In many cases, quantization can be viewed as the fundamental element that distinguishes lossy data compression from lossless data compression, and the use of quantization is nearly always motivated by the need to reduce the amount of data needed to represent a signal.

A typical digital video codec design starts with conversion of camera-input video from RGB color format to YCbCr color format, and often also chroma subsampling to produce a 4:2:0 (or sometimes 4:2:2 in the case of interlaced video) sampling grid pattern. The conversion to YCbCr provides two benefits: first, it improves compressibility by providing decorrelation of the color signals; and second, it separates the luma signal, which is perceptually much more important, from the chroma signal, which is less perceptually important and which can be represented at lower resolution.

Many different video codec designs exist in the prior art. Of these, the most significant recent development is video codecs technically aligned with the standard MPEG-4 Part 10 (a technically aligned standard with the ITU-T's H.264 and often also referred to as AVC). This emerging new standard is the current state of the art of ITU-T and MPEG standardized compression technology, and is rapidly gaining adoption into a wide variety of applications. It contains a number of significant advances in compression capability, and it has recently been adopted into a number of company products, including for example the PlayStation Portable, iPod, the Nero Digital product suite, Mac OS X v10.4, as well as HD DVD/Blu-ray Disc.

H.264 encoding and decoding are very computationally intensive, so it is advantageous to be able to perform them on a parallel processing architecture to speed the process up and enable real time encoding and decoding of digital video signals even if they are High Definition format. To do H.264 encoding and decoding on a parallel processing computing platform (any parallel processing platform with any number of parallel computing channels will suffice to practice the invention), it is necessary to break the encoding and decoding problems down into parts that can be computed simultaneously and which are data independent, i.e., no dependencies between data which would prevent parallel processing.

### The Basics of H.264 Video Codec

In the main profile of the H.264 codec, compression is usually performed on video in the YCbCr 4:2:0 format with 8 bits per channel representation. The luminance component of the frame is divided into 16×16 pixel blocks called luma macroblocks and the chrominance Cb and Cr channels are divided into 8×8 Cb and Cr blocks of pixels, collectively referred to as chroma macroblocks.

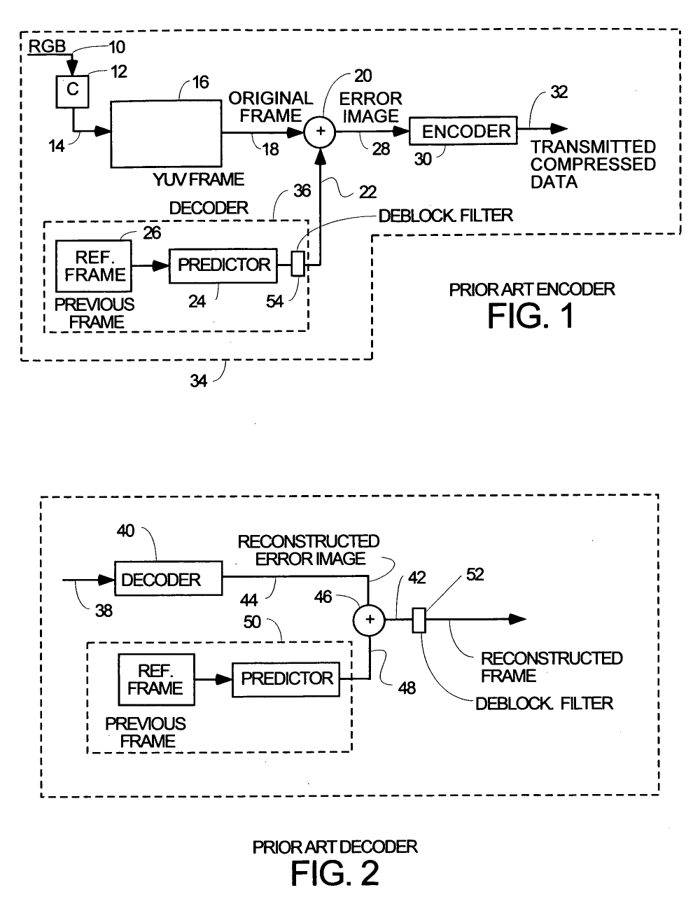

Referring to FIG. 1, there is shown a block diagram of a prior art video data encoder to compress raw video pixel luminance data down to a smaller size. Chrominance data is compressed in a very similar manner and will not be discussed in detail. The raw video input pixel data in RGB format arrives on line 10. RGB format signals have redundancy between the red, green and blue channels, so converter 12 converts this color space into a stream of pixel data 14 in YCbCr format. The Y pixels are luminance only and have no color information. The color information is contained in the Cb and Cr channels. Since the eye is less sensitive to color changes, the Cb and Cr channels are sampled at one fourth the resolution of the Y channel. A buffer 16 stores a frame of YCbCr data. This original frame data is applied on line 18 adder 20. The other input 22 to the summer is the predicted frame which is generated by predictor 24 from a previous frame of pixels stored in buffer 26.

Like the previous MPEG standards, H.264 codec employs temporal redundancy. The H.264 has introduced the following main novelties:

1) macroblock-based prediction: each macroblock is treated as a stand-alone unit, and the choice between I and P modes is on macroblock rather than entire frame level, such that a single frame can contain both I and P blocks. Macroblocks can be grouped into slices.

2) an additional level of spatial redundancy utilization was added by means of inter-prediction. The main idea is to predict the macroblock pixel from neighbor macroblocks within the same frame, and apply transform coding to the difference between the actual and the predicted values.

3) P macroblocks, even within the same frame, can use different reference frames.

The residual macroblock is encoded in encoder 30 and the encoded data on line 32 is transmitted to a decoder elsewhere or some media for storage. Encoder 30 does a Discrete Cosine Transform (DCT) on the error image data to convert the functions defined by the error image samples. The integer luminance difference numbers of the error image define a function in the time domain (because the pixels are raster scanned sequentially) which can be transformed to the frequency domain for greater compression efficiency and fewer artifacts. The DCT transform outputs integer coefficients that define the amplitude of each of a plurality of different frequency components, which when added together, would reconstitute the original time domain function. Each coefficient is quantized, i.e., only some number of the most significant bits are kept of each coefficient and the rest are discarded. This cause losses in the original picture quality, but makes the transmitted signal more compact without significant visual impairment of the reconstructed picture. For the coefficients of the higher frequency components, more aggressive quantization can be performed (fewer bits kept) because the human eye is less sensitive to the higher frequencies. More bits are kept for the DC (zero frequency) and lower frequency components because of the eye's higher sensitivity.

All the circuitry inside box 34 is the encoder, but the predicted frame on line 22 is generated by a decoder 36 within the encoder.

FIG. 2 is a block diagram of the decoder circuitry which decompresses the received compressed signal on line 38 and outputs the reconstructed frame on line 42. Decoder 40 peforms an inverse DCT and inverse quantization on the incoming compressed data on line 38. This results in a reconstructed error image on line 44. This is applied to summer 46 which adds each error image pixel to the corresponding pixel in the predicted frame on line 48. The predicted frame is exactly the same predicted frame as was created on line 22 in FIG. 1 because the decoder 36 there is the same decoder as the circuitry within box 50 in FIG. 2. The error plus the predicted pixel equals the original pixel luminance.

In inter-prediction mode, each P-block (or each subdivision thereof) has a motion vector which points to the same size block of pixels in a previous frame using a Cartesian x,y coordinate set which are the closest in luminance values to the pixel luminance values of the macroblock. The differences between the reference macroblock luminance values and the reference block luminance values are encoded as a macroblock of error values which are integers which range from −255 to +255. The data transmitted for the compressed macroblock is these error values and the motion vector. The motion vector points to the set of pixels in the reference frame which will be the predicted pixel values in the block being reconstructed in the decoder. This P-block encoding is the form of compression that is used most because it uses the fewest bits.

The differences between the luma values of the block being encoded and the reference pixels are then encoded using DCT and quantization. In the preferred embodiment, the macroblock of error values is divided into four 4×4 blocks of error numbers. Each error number is the number of bits it takes to represent an integer ranging from −255 to +255. Chroma encoding is slightly different because the macroblocks are only half the resolution of the luma macroblocks.

The DCT, and in particular the DCT-II, is often used in signal and image processing, especially for lossy data compression, because it has a strong “energy compaction” property: most of the signal information tends to be concentrated in a few low-frequency components of the DCT. This allows compression by quantization because more bits of the less significant high frequency components can be removed and more bits of the more significant low frequency components can be kept. For example, suppose 16 bits are output for every frequency component coefficient. For the less significant higher frequency components, only two bits might be kept, whereas for the most significant component, the DC component, all 16 bits might be kept. Typically, quantization is done by using a quantization mask which is used to multiply the output matrix of the DCT transform. The quantization mask does scaling so that more bits of the lower frequency components will be retained.

The discrete cosine transform is defined mathematically as follows.

$$b ( u , v ) = {\sum }_{x} {\sum }_{y} a ( x , y ) cos \frac{ux 2 π}{4} cos \frac{vy 2 π}{4} \qquad ( 1 )$$

As an example of a DCT transform, a DCT is used in JPEG image compression, MJPEG, MPEG, and DV video compression. In these compression schemes, the two-dimensional DCT-II of N×N blocks is computed and the results are quantized and entropy coded. In this example, N is typically 8 so an 8×8 block of error numbers is the input to the transform, and the DCT-II formula is applied to each row and column of the block. The result is an 8×8 transform coefficient array in which the (0,0) element is the DC (zero-frequency) component and entries with increasing vertical and horizontal index values represent higher vertical and horizontal spatial frequencies. The DC component contains the most information so in more aggressive quantization, the bits required to express the higher frequency coefficients can be discarded.

In H.264, the macroblock is divided into 16 4×4 blocks, each of which is transformed using a 4×4 DCT. In some intra prediction modes, a second level of transform coding is applied to DC coefficients of the macroblocks, in order to reduce the remaining redundancy. The 16 DC coefficients are arranged into a 4×4 matrix, which is transformed using the Hadamard transform.

Also, only luminance values will be discussed unless otherwise indicated although the same ideas apply to the chroma pixels as well.

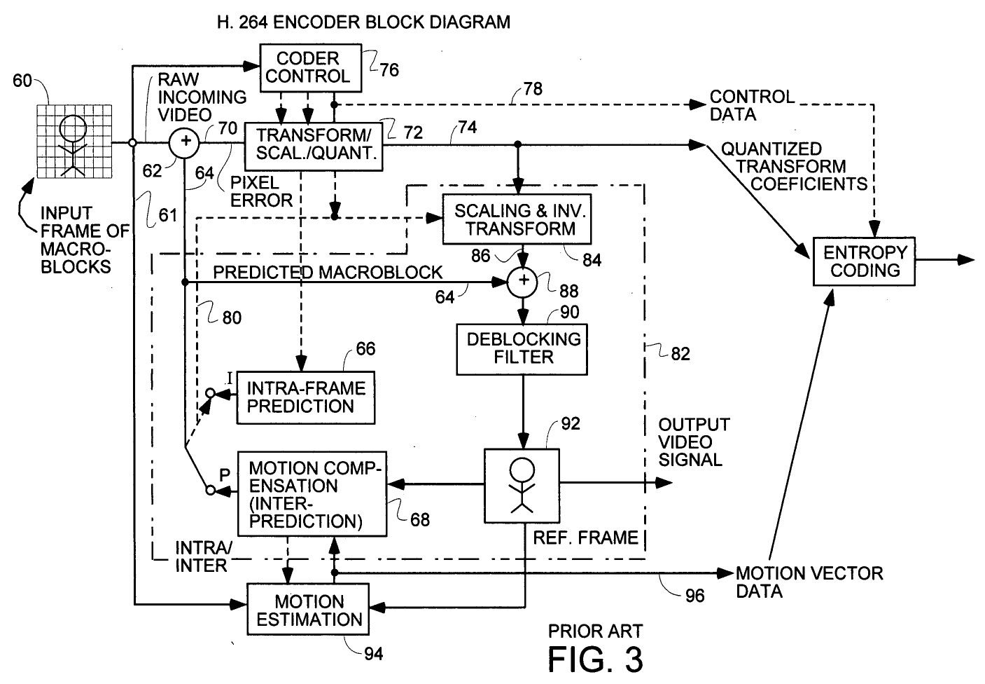

Referring to FIG. 3, there is shown a block diagram of a prior art H.264 encoder. The raw incoming video to be compressed is represented by frame 60. Each pixel of each macroblocks of the incoming frame 60 is subtracted in summer 62 from a corresponding pixel of a predicted macroblock on line 64.

The predicted frame macroblock is generated either as an I-block by intraframe prediction circuit 66 or motion compensation circuit 68.

The resulting per pixel error in luminance results in a stream of integers on line 70 to a transformation, scaling and quantization circuit 72. There a Discrete Cosine Transform is performed on the error numbers and scaling and quantization is done to compress the resulting frequency domain coefficients output by the DCT. The resulting compressed luminance data is output on line 74.

A coder control block 76 controls the transformation process and the scaling and quantization and outputs control data on line 78 which is transmitted with the quantized error image transform coefficients. The control data includes which mode was used for prediction (I or P), how strong the quantization is, settings for the deblocking filter, etc.

For each macroblock either intra-frame prediction (which generates an I-block macroblock) is used or interframe prediction (which generates a P-block macroblock) is used to generate the macroblock. A control signal on line 80 controls which type of predicted macroblock is supplied to summer 62.

To generate a predicted macroblock, a reference frame is used. The reference frame is the just previous frame and is generated by an H.264 decoder within the encoder. The H.264 decoder is the circuitry within block 82. Circuit 84 dequantizes the compressed data on line 74, and does inverse scaling and an inverse DCT transformation.

The resulting pixel luminance reconstructed error numbers on line 86 are summed in summer 88 with the predicted pixel values in the predicted macroblock on line 64. The resulting reconstructed macroblocks are processed in deblocking filter 90 which outputs the reconstructed pixels of a video frame shown at 92. Video frame 92 is basically the previous frame to the frame being encoded and serves as the reference frame for use by motion estimation circuit 94 which generated motion vectors on line 96.

The motion estimation circuit 94 compares each macroblock of the incoming video on line 61 to the macroblocks in the reference frame 92 and generates a motion vector which is a vector to the coordinates of the origin of a macroblock in the reference frame whose pixels are the closest in luminance values to the pixels of the macroblock to which the motion vector pertains. This motion vector per macroblock on line 96 is used by the motion compensation circuit 68 to generate a P-block mode predicted macroblock whose pixels have the same luminance values at the pixels in the macroblock of the reference frame to which the motion vector points.

The intraframe prediction circuit 66 just uses the values of neighboring pixels to the macroblock to be encoded to predict the luminance values of the pixels in the I-block mode predicted macroblock output on line 64.

### Deblocking Filter in H.264 Codec

A particularly computationally intensive part of the H.264 codec is the deblocking filter, also referred to as the in-loop filter, whose main purpose is the reduction of artifacts (referred to as the blocking effect) resulting from transform-domain quantization, often visible in the decoded video and disturbing the viewer. In the H.264 ecoder, the deblocking filter also allows improving the accuracy of inter-prediction, since the reference blocks are taken after the deblocking filter is applied.

In state-of-the-art implementation of the H.264 decoder, the deblocking filter can take up to 30% of the computational complexity. The H.264 standard defines a specific deblocking filter, which is an adaptive process acting like a low pass filter to smooth out abrupt edges and does more smoothing if the edges between 4×4 blocks of pixels are more abrupt. The deblocking smoothes the edges between macroblocks so that they become less noticeable in the reconstructed image. In MPEG2 and MPEG4, deblocking filter is not part of the standard codec, but can be applied as a post-processing operation on the decoded video.

The H.264 standard introduced the deblocking filter as part of the codec loop after the prediction. In the decoder of FIG. 2, the deblocking filter is block 52. This means that a deblocking filter must also be included in the position of block 54 in the prior art H.264 encoder in FIG. 1 since the H.264 encoder implicitly includes a decoder and that decoder must act exactly like the decoder at the receiver end of the transmission or in the playback circuit that decompresses video data stored on a media such as a DVD.

Because the DCT transform in the H.264 standard is done on 4×4 blocks, the boundaries between 4×4 blocks inside a macroblock and between neighbor macroblocks may be visible (edge refers to a boundary between two blocks). In order to reduce this effect, a filter must be applied on the 16 vertical edges and 16 horizontal edges for the luma component and on 4 vertical and 4 horizontal edges for each of the chroma components.

When we say edge filtering, we refer to changing the pixels in the blocks on the left and the right of the edge. For vertical edge, each of the 4 lines of 4 pixels in the 4×4 block on the left and each of the 4 lines in the block on the right from the edge must undergo filtering. Each filtering operation affects up to three pixels on either side of the edge. The amount of filtering applied to each edge is governed by boundary strength ranging from 0 to 4, and depending on the current quantization parameter and the coding modes of the neighboring blocks. This setting applies to the entire edge (i.e. to four rows or columns belonging to the same edge). Two 4×4 matrices with boundary strengths for vertical and horizontal edges are computed for this purpose. The actual amount of filtering also depends on the gradient of intensities across the edge, and is decided for each row or column of pixels crossing the edge.

In the H.264 standard, in order to account for the need to do filtering of different strength, two different filters may be applied to a line of pixels. These filters are referred to as a long filter (involving the weighted sum of six pixels, three on each side of the edge) and the short filter (involving the weighted sum of four pixels, two on each side of the edge). The decision of which filter to use is separate for each line in the block. Each line can be filtered with the long filter, the short filtered, or not filtered at all.

### Prior Art Implementations of Parallel Deblocking Filters for H.264 Codec

The H.264 does not prescribe any parallelization of the deblocking filter. It only requires that the vertical luma and chroma edges are deblocked prior to the horizontal ones. However, parallelization to accomplish this order of calculation is an implementation detail left up to the designer, and that is essential to achieving the advantages the invention achieves.

In several prior art implementations of the deblocking filter for the H.264 codec, this data dependency was used to some extent in order to improve the computational efficiency of the deblocking filter. Here, we refer to the following prior art:

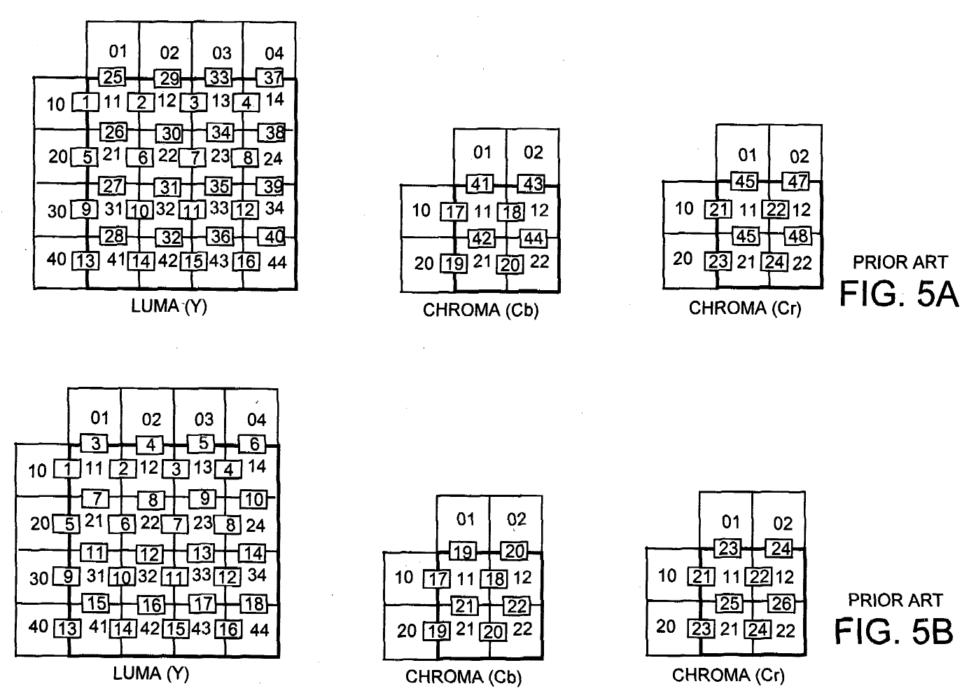

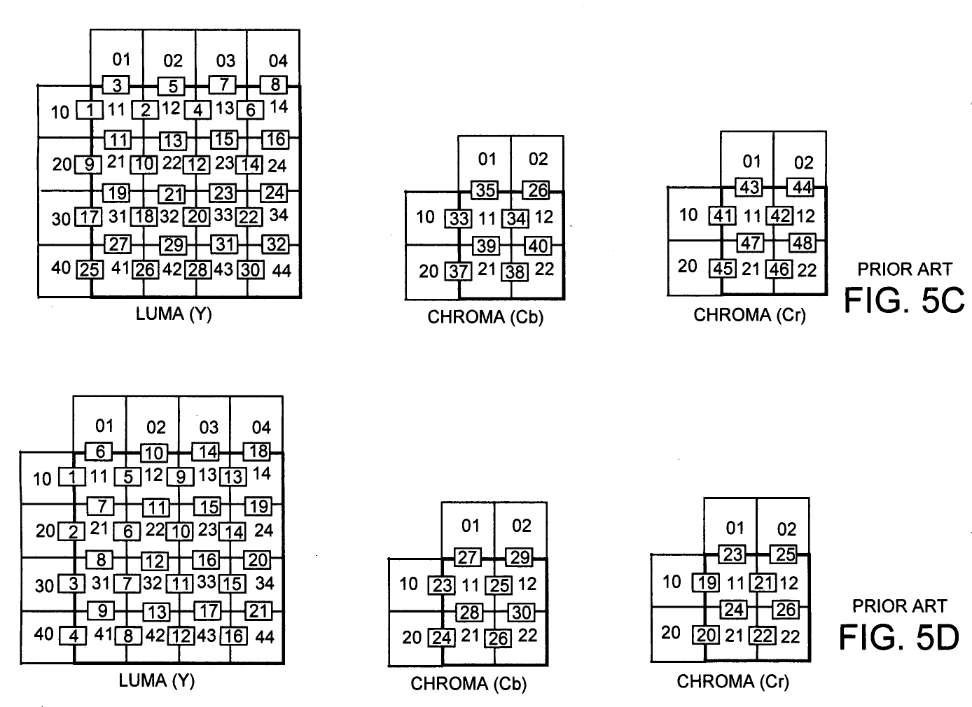

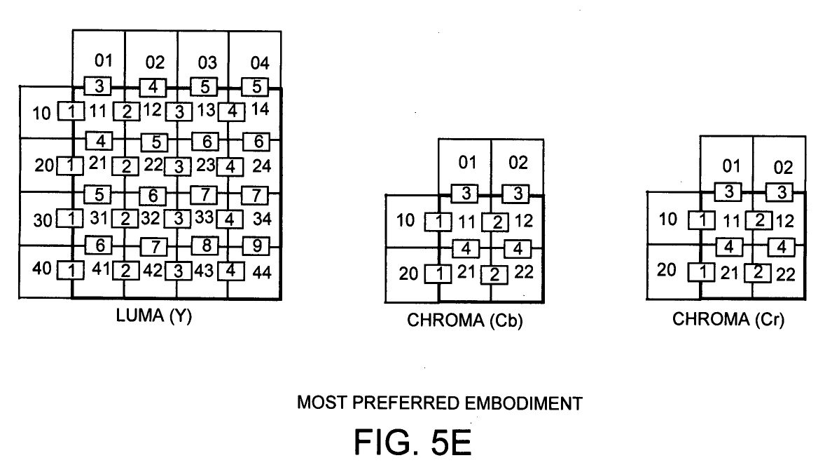

1. Y.-W. Huang et al., Architecture design for deblocking filter in H.264/JVT/AVC, Proceeding IEEE International Conference on Multimedia and Expo (2003), proposed an architecture in which two adjacent blocks are stored in a 4×8 pixel array, from which the lines of pixels are fed into a one-dimensional filter, which performed the processing of pixels. The processing is first applied to the vertical luma edges in raster scan order, then to the horizontal luma edges, in raster scan order. Afterwards, the chroma edges are filtered. The order in which the horizontal and luma vertical and horizontal edges are deblocked is as shown in FIG. 5A. All the edges are processed in 48 iterations. In each block, the processing of each line of pixels is performed sequentially by the one-dimensional filter (i.e., for each block, it takes another 4 “internal” iterations to carry out the filtering).

2. V. Venkatraman et al., Architecture for Deblocking Filter in H.264, Proceedings Picture Coding Symposium (2004) showed a pipeline architecture, which is an improvement to the architecture of Huang et al., in which two one-dimensional filters are operated in parallel, processing vertical edges in raster scan order and simultaneously, with a delay of two iterations, horizontal edges, in pipeline manner in the order shown in FIG. 5B. The order in which the horizontal and luma vertical and horizontal edges are deblocked is as shown in FIG. 5B. All the edges are processed in 24 iterations. Like in the method of Huang et al., in each block, the processing of each line of pixels is performed sequentially by the one-dimensional filter.

3. Another pipelined deblocking filter is taught by Y.-K. Kim et al., Pipeline Deblocking Filter, U.S. Patent Application Publication 20060115002 (June 2006 Samsumg Electronics). The vertical and horizontal edges are filtered in the order presented in FIG. 5C, in the total of 48 iterations, where in each block, the processing of each line of pixels is performed sequentially by the one-dimensional filter. The order in which the horizontal and luma vertical and horizontal edges are deblocked is as shown in FIG. 5C.

4. A multi-stage pipeline architecture is taught by P. P. Dang, Method and Apparatus for Parallel Processing of In-Loop Deblocking Filter for H.264 Video Compression Standard, U.S. Patent Application Publication 20060078052 (December 2005). In this approach, sequential filtering of luma and chroma edges takes 30 iterations. The filtering order is presented in FIG. 5D.

### A Deblocking Filter Process According to the Invention

The invention claimed herein is a method and apparatus to do deblocking filtering on any parallel processing platform, utilizing in the best way the data dependency.

We identify three levels of parallelization in the deblocking filter process:
1. Edge filtering consists of processing four lines of pixels in the blocks on two sides of the edge. All the lines within the blocks can be processed in parallel, as opposed to filtering each line separately.
2. Several edges can be deblocked simultaneously, as the data dependency allows.
3. Deblocking of luma and chroma components can be performed simultaneously, as there is no data dependency between them.

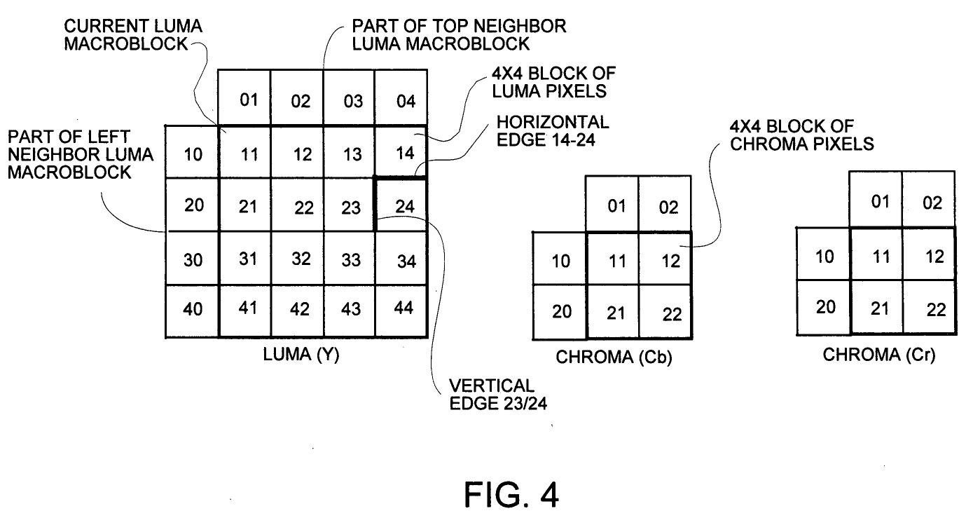

All luma and chroma horizontal and vertical edges are filtered in 8 iterations in the order shown in FIG. 5E in the most preferred embodiment. The particular edges which are deblocked during each iteration are identified by the iteration numbers written in the blocks superimposed on each edge. Edges are designated by the block numbers that bound them where the block number are the numbered blocks in FIG. 4 (these same block numbers are repeated in FIG. 5E). In our notation convention used hereinafter, vertical edges (i.e., edges between two horizontally stacked block) are denoted by |, e.g., 10|11 denotes a vertical edge between the blocks numbered 10 and 11; horizontal edges are denoted by , e.g., 01-11 denotes a horizontal edge between the blocks numbered 01 and 11. As an example, the edges which are simultaneously deblocked during the first iteration are: vertical luma edge 10|11; vertical luma edge 20|21; vertical luma edge 30|31; vertical luma edge 40|41; vertical chroma edge 10|11 in the Cb channel; vertical chroma edge 20|21 in the Cb channel; vertical chroma edge 10|11 in the Cr channel; vertical chroma edge 20|21 in the Cr channel. Study of which edges are deblocked during each iteration indicates data dependency is respected but that maximum use of the three above identified forms of parallelism are utilized to reduce the total number of iterations to 8.

The general notion here is to speed up the deblocking process by dividing the problem up into sub-problems which are data independent of each other such that each sub-problem can be solved on a separate computational path in any parallel processing architecture.

A possible order of edge processing according to our invention, utilizing in the best way the data dependency is shown in FIG. 5E. Using a parallel processing architecture computer described elsewhere herein, all the luma and chroma vertical and horizontal edges can processed in at most eight iterations utilizing all the three levels of parallelism. This offers a significant speed advantage over prior art implementations. This is the theoretically best possible parallelization of the deblocking filter.

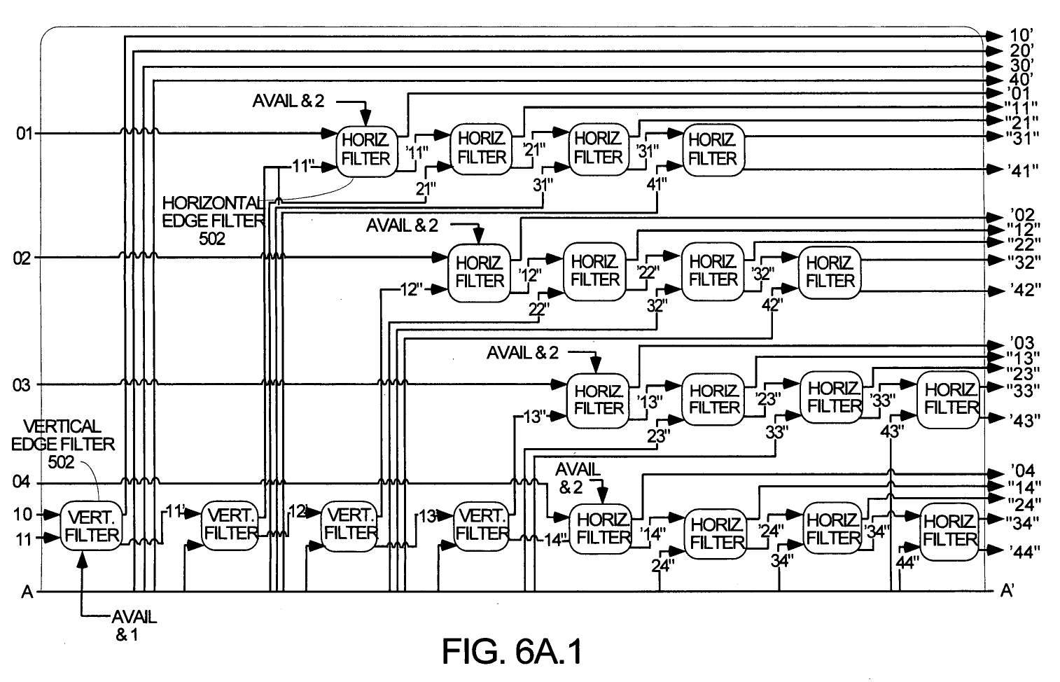

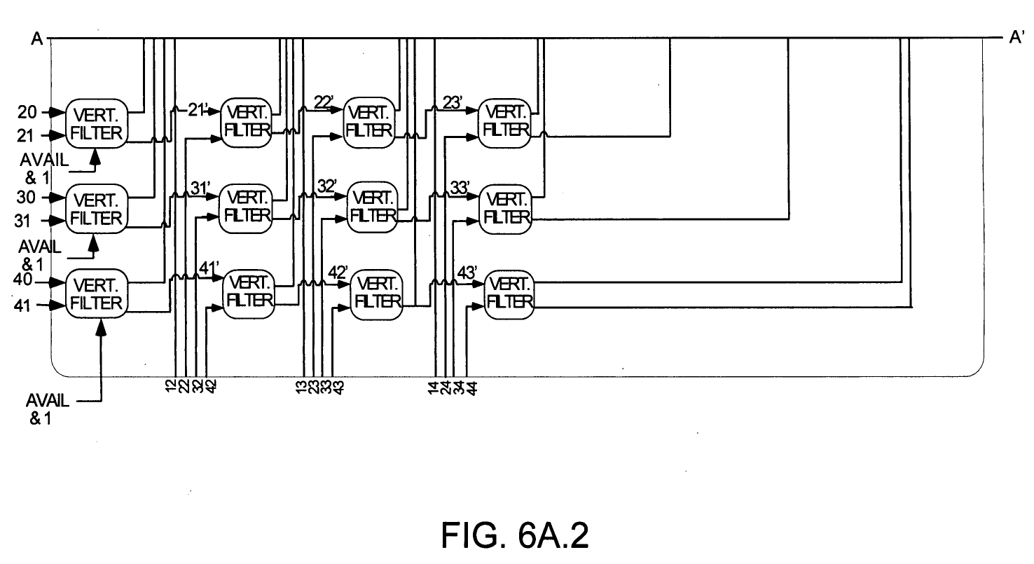

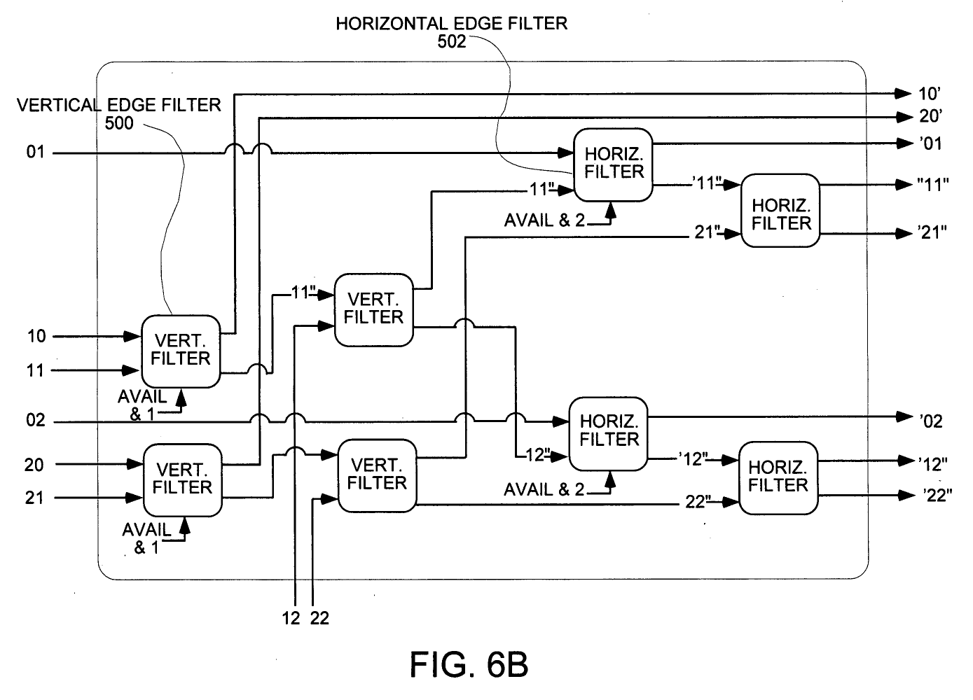

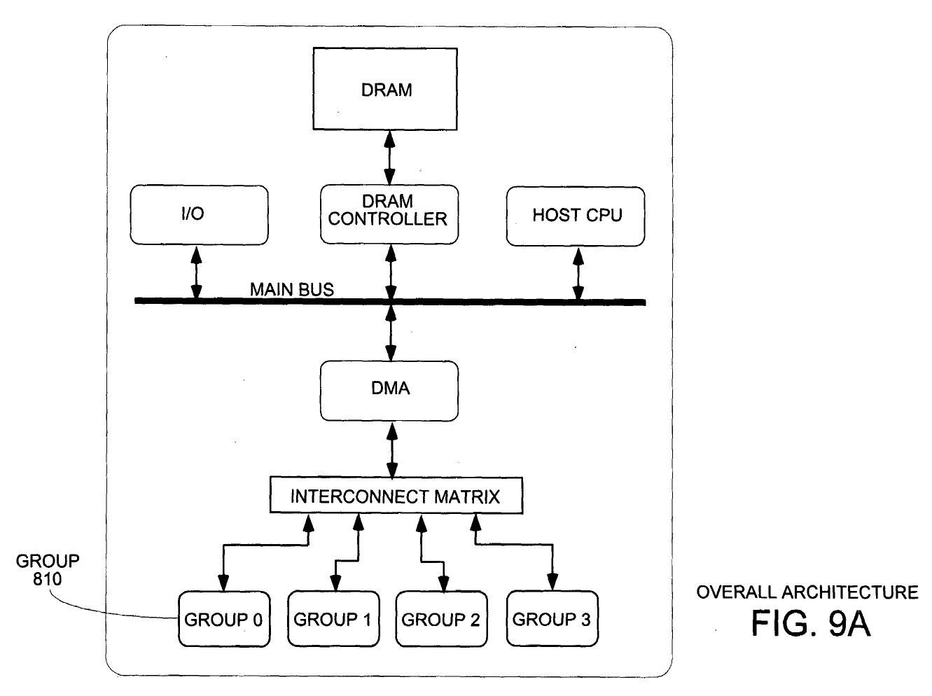

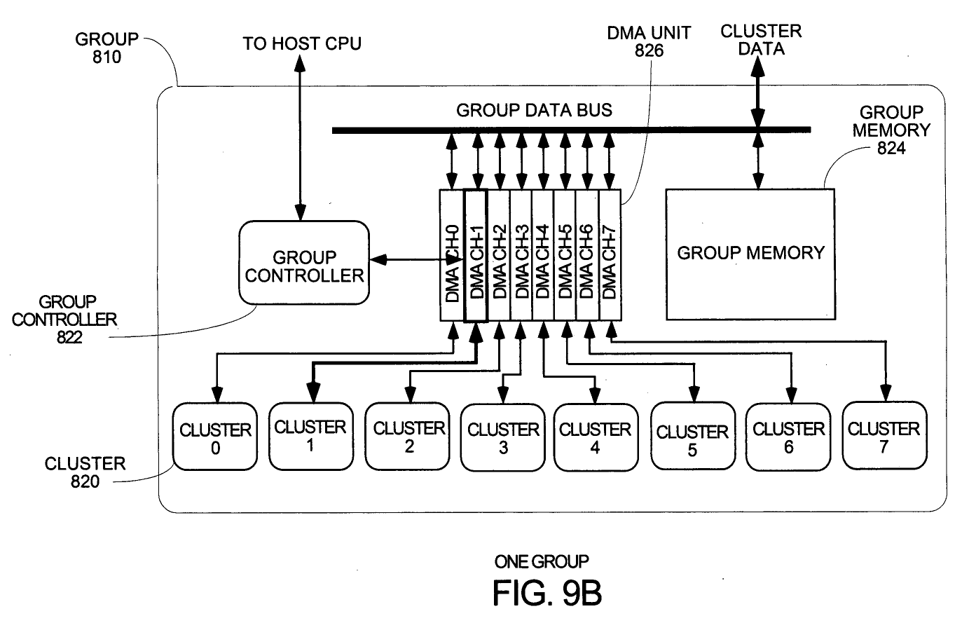

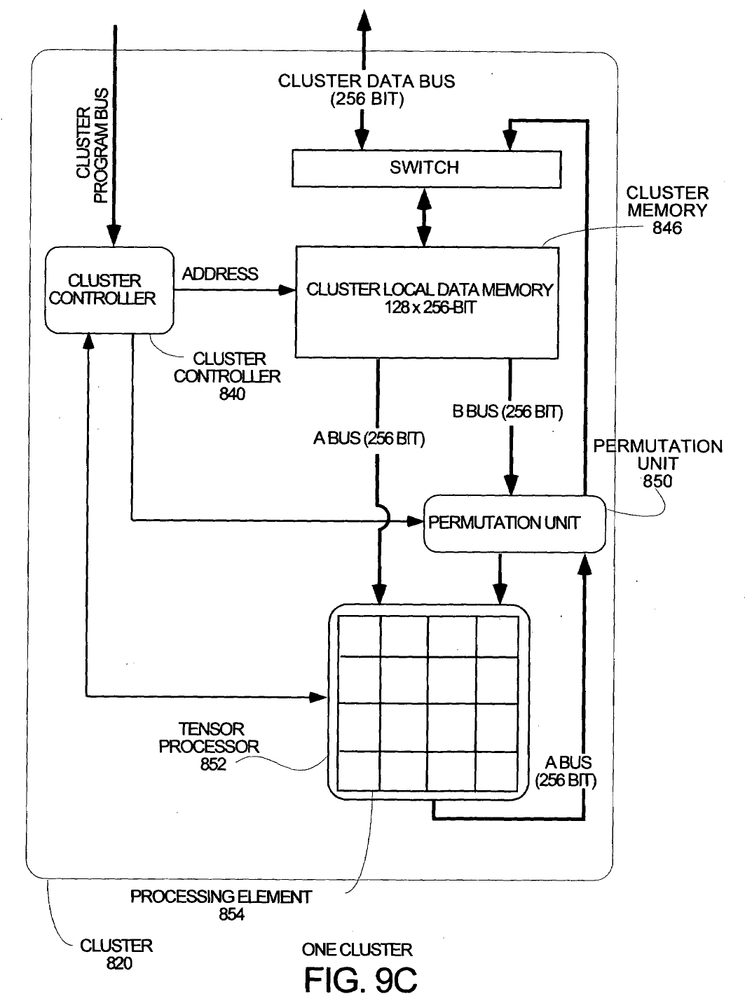

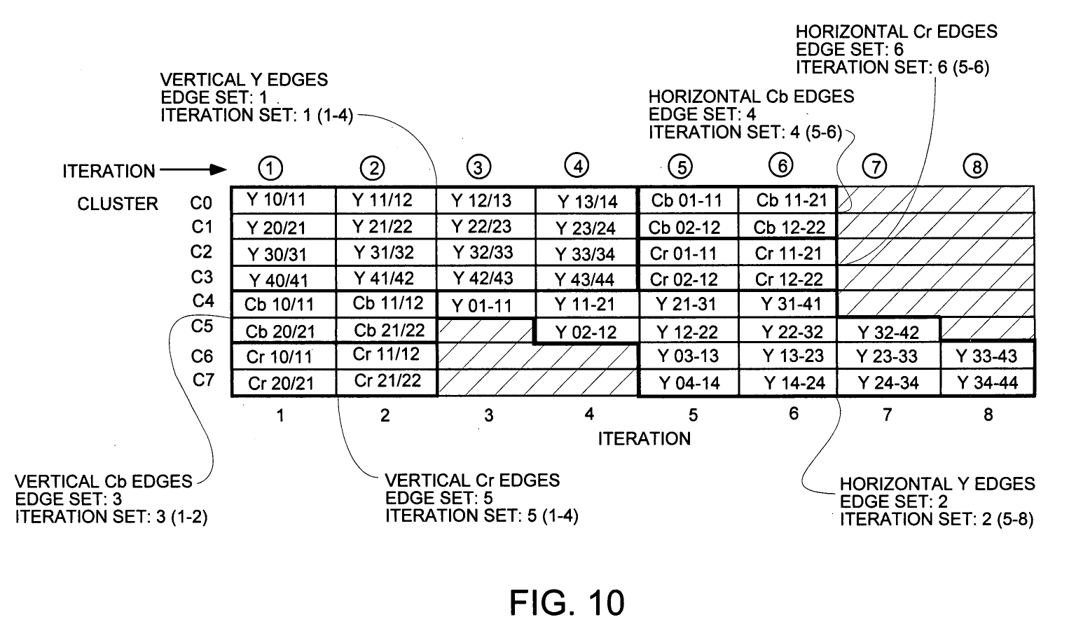

FIG. 6, comprised of FIGS. 6A and 6B, depicts the data flow in a parallel system implementing this processing order for deblocking of luma (FIG. 6A) and chroma (FIG. 6B) edges. This data flow of FIGS. 6A and 6B represents either a hardwired system implemented in hardware, or a software system implemented on a programmable parallel architecture, or both. In other words, each vertical filter and each horizontal filter in FIGS. 6A and 6B may be: 1) a separate gate array or hard wired circuit; 2) a cluster or computational unit of a parallel processing computer which is programmed to carry out the filtering process; 3) a separate thread or process on a sequential computer. The terminology “iteration” in the claims means an interval in time during which the deblocking of the specified edges for the iteration is being performed. The following terminology in the claims directed to the sequence of processing the vertical and horizontal luma and chroma edges means the following things: 1) “first means” means either hardware circuitry or one or more programmed computers or a combination of both deblocking the edges specified in FIG. 10 in the first and second iterations according to the data flow of FIGS. 6A and 6B; 2) “second means” means either hardware circuitry or one or more programmed computers or a combination of both deblocking the edges specified in FIG. 10 in the third and fourth iterations according to the data flow of FIGS. 6A and 6B; 3) “third means” means either hardware circuitry or one or more programmed computers or a combination of both deblocking the edges specified in FIG. 10 in the fifth and sixth iterations according to the data flow of FIGS. 6A and 6B; 4) “fourth means” means either hardware circuitry or one or more programmed computers or a combination of both deblocking the edges specified in FIG. 10 in the seventh and eighth iterations according to the data flow of FIGS. 6A and 6B. The system comprises independent filter units 500 for vertical edge filtering and filter units 502 for horizontal edge filtering. The filters operate in parallel, processing the blocks in the order shown in FIG. 5E. In a hardwired implementation, each filter unit 500 and 502 is a dedicated hardware unit. In a software implementation, each filter unit 500 and 502 is implemented in software and its execution is carried out by a programmable processing unit. The numbered input lines carry data corresponding to the pixels in the block indicated by the number on the input line. The specific blocks identified by the numbers on each input line are specified in FIG. 4. Each filter receives the data from two blocks that define the edge being deblocked. Each column of filters represents one iteration. There are only 8 iterations total. There are only four iterations to deblock all chroma edges, as illustrated in FIG. 6B, but these iterations overlap with luma iterations using processors of the AVIOR architecture specified later in FIGS. 9A, 9B and 9C which would otherwise be idle during these iterations. The best way to visualize which luma and chroma edges are being simultaneously deblocked is in the diagram of FIG. 10.

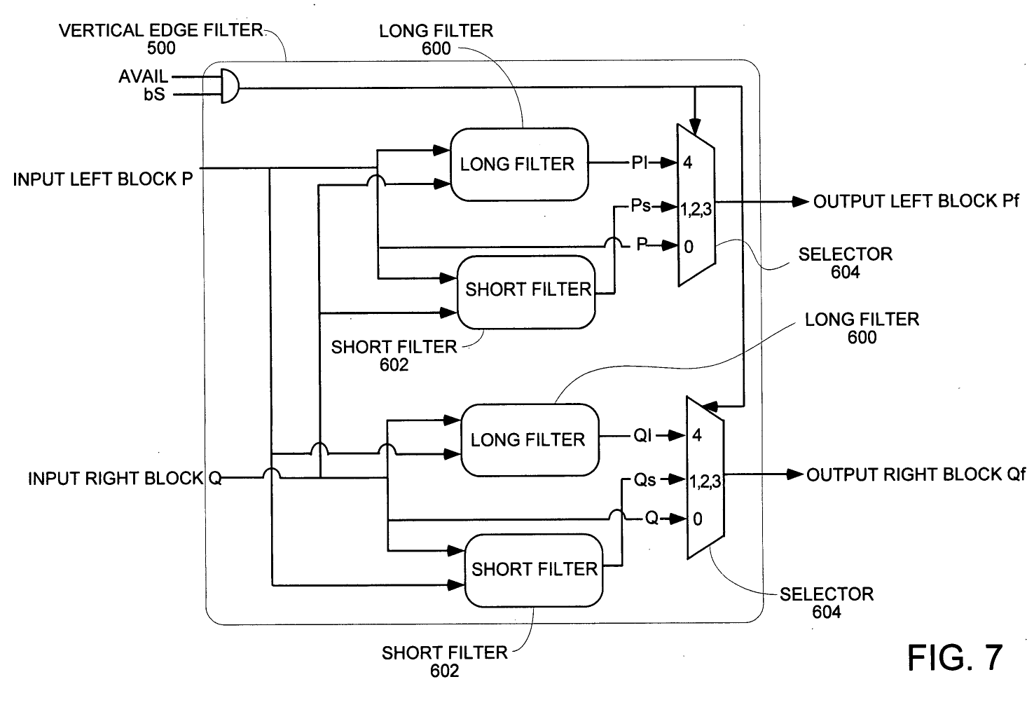

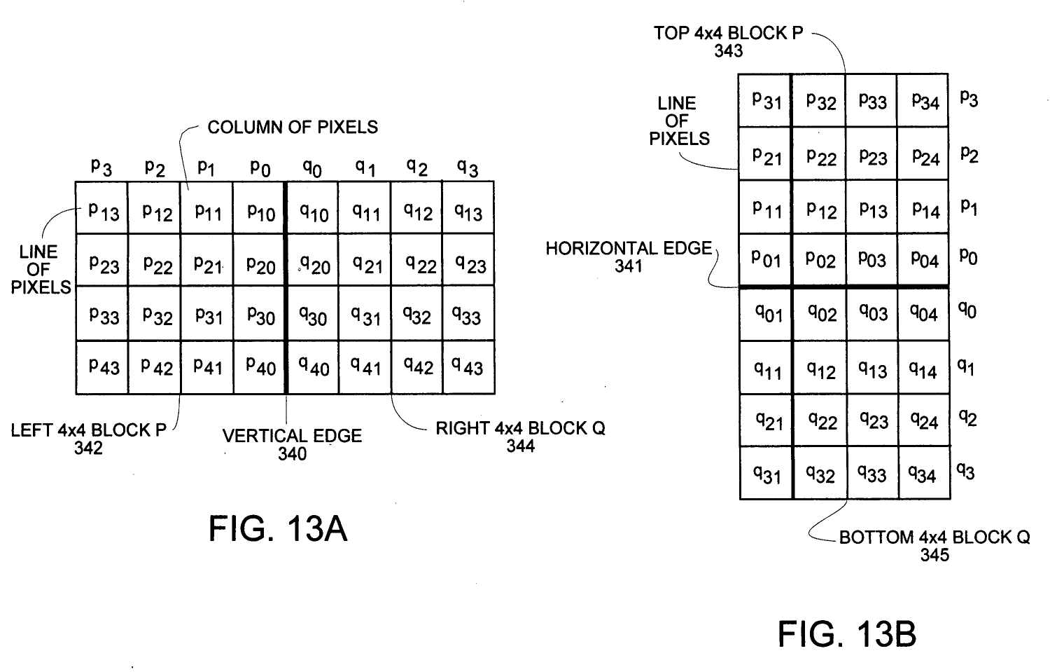

A schematic filter unit for vertical edge filtering is depicted in FIG. 7. It consists of the long filter 600 and the short filter 602. The long filter 600 and the short filter 602 can be performed simultaneously, for example, if they are implemented as dedicated hardware units. The pixel data from left 4×4 block (numbered 342 in FIG. 13A and denoted as P hereinafter) and right 4×4 block (numbered 344 in FIG. 13A and denoted Q hereinafter) that bound the edge being deblocked are fed to the filters as illustrated in the diagram. The terminology “means for doing the long filter and short filter deblocking calculation” in the claims means either gate arrays, hard wired circuits, computational clusters of a parallel processing computer or separate strings of a sequential multitasking computer that perform the long filter and short filter calculations specified in the H.264 specification on the left or right block of pixels (left or right as further specified in the claim) that define an edge. Each filter computes the respective result assuming that for each line of pixels, this outcome is used. In FIG. 7, the outcomes of the long filters are 4×4 filtered blocks denoted by Pl and Ql, and the outcomes of the short filters are 4×4 filtered blocks denoted by Ps and Qs. At the end, for each line of pixels, one of the results (long filter, short filter, or no filter) is selected by matrix selector 604, according to the boundary strength and availability and boundary strength parameters. That is, the final outcomes, denoted by Pf and Qf in FIG. 7 are 4×4 blocks, formed as follows: each line of 4 pixels in Pf and the corresponding line of 4 pixels in Qf are taken as the corresponding lines either in Pl and Ql. or in Ps and Qs, or in P and Q, according to the selection made for this line.

The selection of which result to chose for each line of pixels is defined in the H.264 standard and depends both on the boundary strength and the pixel values in the line. For example, for boundary strength equal to 4, the long filter is selected for the first line of four pixels p₁₃ . . . p₁₀ in FIG. 13A if |p₁₀−p₁₂|<β and |p₁₀−q₁₀|<(α>>2+2). Here α and β are scalar parameters pre-computed according to the H.264 standard specifications.

The operation of the long filter 600 and the short filter 602 and the selection 604 thereof can be represented as a sequence of tensor operations on 4×4 matrices (where by tensor we imply a matrix or a vector, and tensor operations refer to operations performed on matrix, its columns, rows, or elements), and carried out on appropriate processing units implemented either in hardware or in software. This approach is used in the preferred embodiment, but computational units with tensor operation capability are not required in all embodiments.

A one-dimensional filter, used in prior art implementation of the deblocking filter, processes the lines in the 4×4 blocks sequentially in four iterations. For example, referring to the notation in FIG. 13A, the lines of pixels p₁₃ . . . p₁₀ and q₁₀ . . . q₁₃ will be filtered in the first iteration, the lines of pixels p₂₃ . . . p₂₀ and q₂₀ . . . q₂₃ will be filtered in the second iteration, the lines of pixels p₃₃ . . . p₃₀ and q₃₀ . . . q₃₃ will be filtered in the third iteration, and the lines p₄₃ . . . p₄₀ and q₄₀ . . . q₄₃ will be filtered in the fourth iteration. Unlikely, a two-dimensional filter represented as a tensor operation is applied to the entire 4×4 matrices P and Q, and in a single computation produces all the four lines of pixels within the 4×4 blocks.

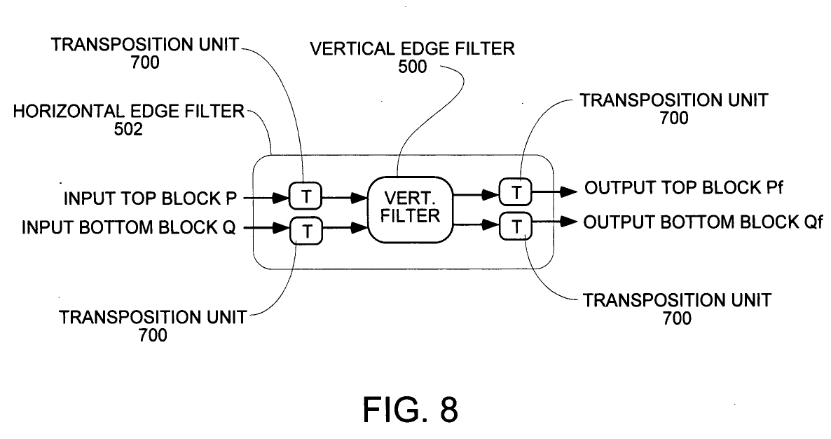

The filtering unit 502 used for horizontal edge filtering can be obtained from the vertical edge filtering unit 500 by means of a transposition operation 700, as shown in FIG. 8. Here, by transposition we imply an operation applied to a 4×4 matrix, in which the columns and the rows are switched, that is, the columns of the input matrix, become the rows of the output matrix.

### The Preferred Embodiment of a Deblocking Filter Process According to the Invention

The preferred platform upon which to practice the parallel deblocking filter process is a massively-parallel, computer with multiple independent computation units capable of performing tensor operations on 4×4 matrix data. An example of a parallel computer having these capabilities is the AVIOR (Advanced VIdeo ORiented) architecture, shown in FIG. 9A.

In this architecture, the basic computational unit is a cluster 820 (depicted in FIG. 9C) a processor consisting of 16 processing elements 854 arranged into a a 4×4 array. This array is referred to as a tensor processor 852. It is capable of working with tensor data in both SIMD (single instruction multiple data) and MIMD (multiple instruction multiple data) modes. Particularly efficient are operations on 4×4 matrices (arithmetic and logical element-wise operations and matrix multiplications) and 4×1 or 1×4 vectors. Each cluster has a local memory 846 and special hardware designated for tensor operations, like the permutation unit 850, capable, for example, of performing efficiently the transposition operation.

A plurality of clusters form a group 810, depicted in FIG. 9B. Each group has a local memory 824, a controller 822 and a DMA (direct memory access) unit, allowing the clusters to operate simultaneously and independently of each other.

The entire architecture consists of a plurality of groups. In the configuration shown in FIG. 9A, the number of clusters in each group is 8 and the total number of groups is 4. In other embodiments, larger or smaller numbers of groups may be employed, and each group may employ larger or smaller numbers of clusters. As clusters, any processors can be used, though processors capable of performing operations on matrix data are preferred.

In the embodiment presented here, we employ only one group for the deblocking filter, while the other groups are free to carry out other processing needed in the H.264 codec or perform deblocking of other video streams in a multiple stream decoding scenario.

In the preferred embodiment of this invention, the parallel deblocking filter employing the parallelization described in FIG. 5E is implemented on the AVIOR architecture. Each cluster is assigned the process of luma or chroma edge deblocking as shown in FIG. 10. During the first iteration, clusters 0 through 7 are assigned to deblock the luma and chroma vertical edges as shown in the first column of FIG. 10. During the second iteration (the second column), all 8 clusters are assigned to deblock the edges defined in the second column of FIG. 10. The assignment of edges for the last six iterations are as defined in FIG. 10, columns 3, 4, 5, 6, 7 and 8. All the relevant blocks are stored in the cluster memory 846. This requires loading two 4×4 blocks denoted by P and Q (numbered 342 and 344 in case of deblocking a vertical edge in FIG. 13A, or 343 and 345 in case of deblocking a horizontal edge in FIG. 13B), performing the necessary tensor operations and writing the filtered blocks Pf and Qf to the cluster memory 846. The order of processing of edges is dictated by the data dependency order presented in FIG. 5E. The processed blocks are collected from all the clusters in the group memory 824.

In actual implementation, the order of edge deblocking may differ from the one presented in FIG. 5E due to reasons of computational unit availability and optimization of allocation of computations on different units. In the most generic case, we can group the edges into the following six sets:

1. Vertical luma edges (Y 10|11, . . . , Y 43|44);

2. Horizontal luma edges (Y 01-11, . . . , Y 34-44);

3. Vertical Cb edges (Cb 10|11, . . . , Cb 21|22);

4. Horizontal Cb edges (Cb 01-11, . . . , Cb 12-22);

5. Vertical Cr edges (Cr 10|11, . . . , Cr 21|22);

6. Horizontal Cr edges (Cr 01-11, . . . , Cr 12-12).

Each of the 6 sets of edges is allocated to a set of computational units, on which it is deblocked in a set of iterations. If two sets of edges are executed in overlapping sets of iterations, this implies that they are executed in parallel. If a set of edges is allocated to a non-singleton set of computational units (i.e., more than a single computational unit), this implies an internal parallelization in the processing of said set of edges.

The actual allocation and order of processing is subject to availability of computational units and data dependency. In the following, we show allocation of processing in the preferred embodiments of the invention, though other allocations are also possible.

### Specific Example of the Process Carried out on a Parallel Architecture with Eight Independent Processing Units

The most computationally-efficient embodiment of the parallel deblocking filter according to our invention is possible on a parallel architecture consisting of at least eight independent processing units. In the AVIOR architecture, this corresponds to one group in the eight-cluster configuration.

FIG. 10 is a diagram illustrating one possible parallelization of luma and chroma edge deblocking on the AVIOR architecture with 8 clusters or any other parallel processing architecture with 8 clusters and similar capabilities to the AVIOR architecture. Iterations go to the right on the horizontal axis, and the cluster number is indicated on the vertical axis. The process goes as follows:

In the first iteration, four vertical luma edges (Y 10|11, . . . , Y 40|41 according to the edge numbering convention presented in FIG. 4) can be deblocked in parallel on clusters 0-3. On the remaining clusters 4-7, vertical chroma edges (Cb 10|11, Cb 20|21 and Cr 10|11, Cr 20|21) are deblocked.

In the second iteration, the next four vertical luma edges to the right (Y 11|12, . . . , Y 41|42) are deblocked in parallel on clusters 0-3. On the remaining clusters 4-7, vertical chroma edges (Cb 11|12, Cb 21|22 and Cr 11|12, Cr 21|22) are deblocked.

In the third iteration, the next four vertical luma edges to the right (Y 12|13, . . . , Y 42|43) are processed in parallel on clusters 0-3. On one of the remaining clusters, e.g. 4, a data independent horizontal luma edge Y 01-11 can be deblocked.

In the fourth iteration, the last four vertical luma edges (Y 13|14, . . . , Y 43|44) are deblocked in parallel on clusters 0-3. On two of the remaining clusters, e.g. 4-5, data independent horizontal luma edges Y 11-21 and Y 02-12 can be deblocked.

In the fifth iteration, luma edges Y 21-31, Y 12-22, Y 03-13 and Y 04-14 are deblocked in parallel on clusters 4-7. On the remaining clusters 0-3, horizontal chroma edges (Cb 01-11, Cb 02-12 and Cr 01-11, Cr 02-12) are deblocked.

In the sixth iteration, luma edges Y 31-41, Y 22-32, Y 13-23 and Y 14-24 are deblocked in parallel on clusters 4-7. On the remaining clusters 0-3, horizontal chroma edges (Cb 11-21, Cb 12-22 and Cr 11-21, Cr 12-22) are deblocked.

In the seventh iteration, luma edges Y 32-42, Y 23-33 and Y 24-34 are deblocked in parallel on any three of the available clusters 0-7, e.g., on clusters 5-7.

In the eight iteration, the last luma edges Y 33-43 and Y 34-44 are deblocked in parallel on any three of the available clusters 0-7, e.g., on clusters 6-7. The total number of iterations is 8.

Using our notation of edge, iteration and cluster sets, we have:
1. the first set of edges (vertical luma) is allocated on the set of clusters 0-3, and processed in the set of iterations 1-4, with full utilization;
2. the second set of edges (horizontal luma) is allocated on the set of clusters 4-7, and processed in the set of iterations 3-8. The utilization is not full, due to data dependency with the first set of edges;
3. the third set of edges (vertical Cb) is allocated on the set of clusters 4-5; and processed in the set of iterations 1-2, with full utilization;
4. the fourth set of edges (horizontal Cb) is allocated on the set of clusters 0-1, and processed in the set of iterations 5-6, with full utilization;
5. the fifth set of edges (vertical Cr) is allocated on the set of clusters 6-7, and processed in the set of iterations 1-2, with full utilization;
6. the sixth set of edges (horizontal Cr) is allocated on the set of clusters 2-3, and processed in the set of iterations 5-6, with full utilization.

Other allocations are possible as well, with the same efficiency. For example, the allocation of Cb and Cr blocks processing can be exchanged.

### Specific Example of the Process Carried out on a Parallel Architecture with Four Independent Processing Units

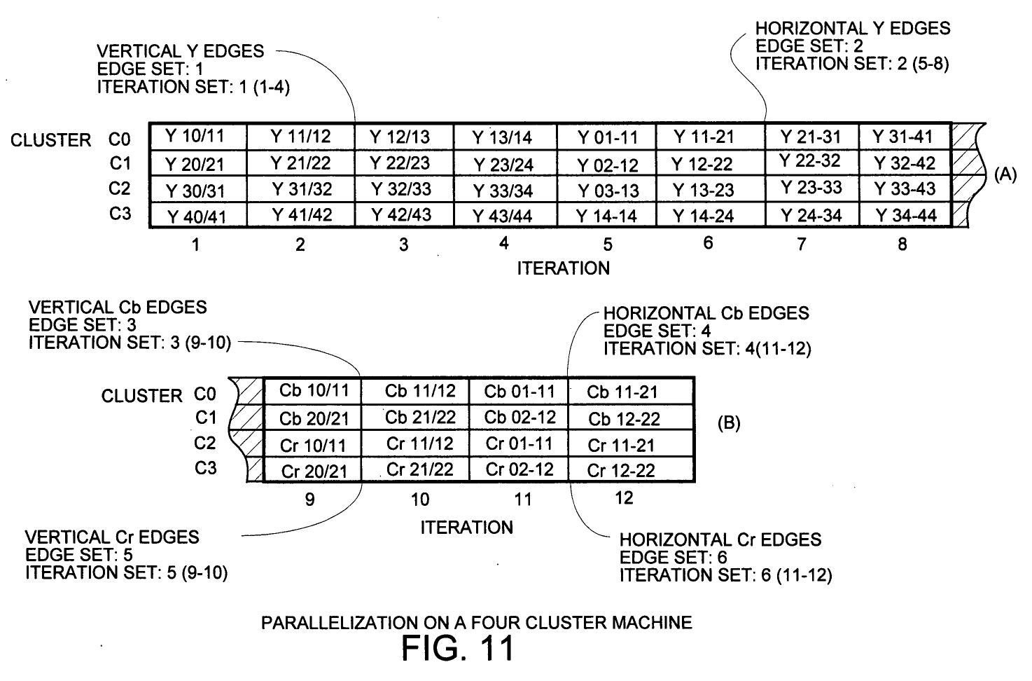

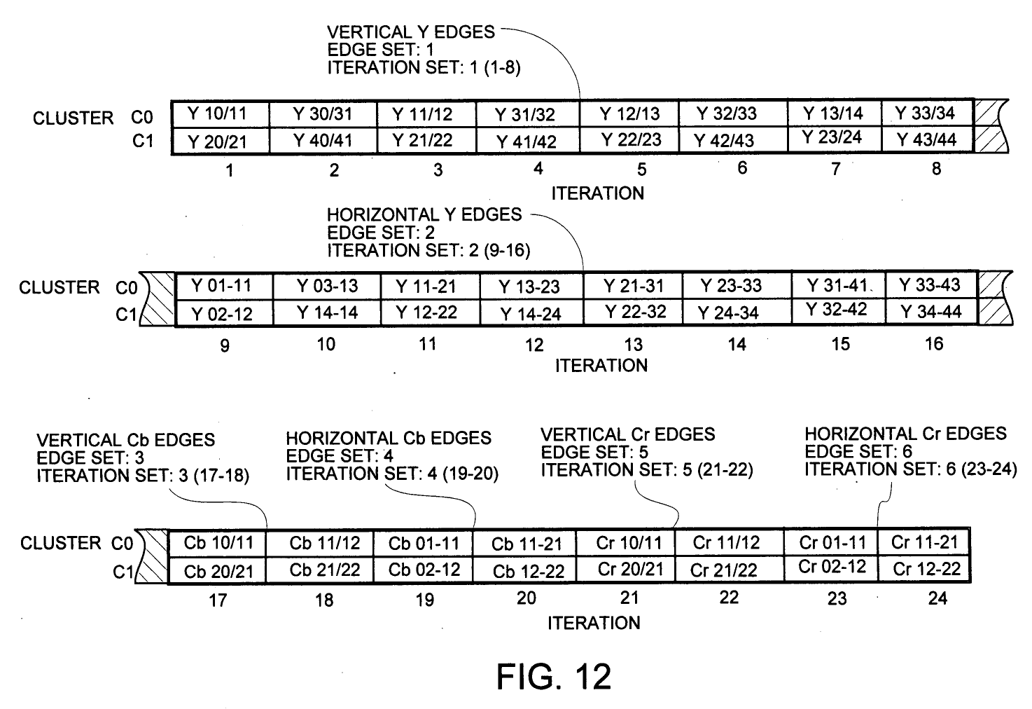

FIGS. 11A and 11B are a diagram illustrating a possible parallelization of luma and chroma edge deblocking on the AVIOR architecture with 4 clusters. FIG. 11A illustrates the luma edges deblocked during the first 8 iterations, and FIG. 11B illustrates the chroma edges deblocked during the las four iterations. The process goes as follows:

In the first iteration, four vertical luma edges (Y 10|11, . . . , Y 40|41 according to the edge numbering convention presented in FIG. 4) are deblocked in parallel on clusters 0-3.

In the second iteration, the next four vertical luma edges to the right (Y 11|12, . . . , Y 41|42) are deblocked in parallel on clusters 0-3.

In the third iteration, the next four vertical luma edges to the right (Y 12|13, . . . , Y 42|43) are processed in parallel on clusters 0-3.

In the fourth iteration, the last four vertical luma edges (Y 13|14, . . . , Y 43|44) are deblocked in parallel on clusters 0-3. This finishes the vertical luma edges.

In the fifth iteration, four horizontal luma edges (Y 01-11, . . . , Y 04-14) are deblocked in parallel on clusters 0-3.

In the sixth iteration, the next four horizontal luma edges to the right (Y 11-21, . . . , Y 14-24) are deblocked in parallel on clusters 0-3.

In the seventh iteration, the next four horizontal luma edges to the right (Y 21-31, . . . , Y 24-34) are processed in parallel on clusters 0-3.

In the eighth iteration, the last four horizontal luma edges (Y 31-41, . . . , Y 34-44) are deblocked in parallel on clusters 0-3. This finishes the horizontal luma edges.

In the ninth iteration, two vertical chroma edges (Cb 10|11 and Cb 20|21) are deblocked in parallel on clusters 0-1, and two vertical chroma edges (Cr 10|11 and Cr 20|21) are deblocked in parallel on clusters 2-3.

In the tenth iteration, two vertical chroma edges (Cb 11|12 and Cb 21|22) are deblocked in parallel on clusters 0-1, and two vertical chroma edges (Cr 11|12 and Cr 21|22) are deblocked in parallel on clusters 2-3. This finishes the vertical chroma edges.

In the eleventh iteration, two horizontal chroma edges (Cb 01-11 and Cb 02-12) are deblocked in parallel on clusters 0-1, and two horizontal chroma edges (Cr 01-11 and Cr 02-12) are deblocked in parallel on clusters 2-3.

In the twelfth iteration, two horizontal chroma edges (Cb 11-21 and Cb 12-22) are deblocked in parallel on clusters 0-1, and two horizontal chroma edges (Cr 11-21 and Cr 12-22) are deblocked in parallel on clusters 2-3. This finishes the horizontal chroma edges. The total number of iterations is 12.

Using our notation of edge, iteration and cluster sets, we have:
1. the first set of edges (vertical luma) is allocated on the set of clusters 0-3, and processed in the set of iterations 1-4, with full utilization;
2. the second set of edges (horizontal luma) is allocated on the set of clusters 0-3, and processed in the set of iterations 5-8, with full utilization;
3. the third set of edges (vertical Cb) is allocated on the set of clusters 0-1, and processed in the set of iterations 9-10, with full utilization;
4. the fourth set of edges (horizontal Cb) is allocated on the set of clusters 0-1, and processed in the set of iterations 11-12, with full utilization;
5. the fifth set of edges (vertical Cr) is allocated on the set of clusters 2-3, and processed in the set of iterations 9-10, with full utilization;
6. the sixth set of edges (horizontal Cr) is allocated on the set of clusters 2-3, and processed in the set of iterations 11-12, with full utilization.

Other allocations are possible as well, with the same efficiency.

### Specific Example of the Process Carried out on a Parallel Architecture with Two Independent Processing Units

FIG. 12 is a diagram illustrating a possible parallelization of luma and chroma edge deblocking on the AVIOR architecture with 2 clusters. The process goes as follows:

In the first iteration, two top vertical luma edges from the first column (Y 10|11 and Y 20|21, according to the edge numbering convention presented in FIG. 4) are deblocked in parallel on clusters 0-1.

In the second iteration, two bottom vertical luma edges from the first column (Y 30|31 and Y 40|41) are deblocked in parallel on clusters 0-1.

In the third iteration, two top vertical luma edges from the second column (Y 11|12 and Y 21|22) are deblocked in parallel on clusters 0-1.

In the fourth iteration, two bottom vertical luma edges from the second column (Y 31|32 and Y 41|42) are deblocked in parallel on clusters 0-1.

In the fifth iteration, two top vertical luma edges from the third column (Y 12|13 and Y 22|23) are deblocked in parallel on clusters 0-1.

In the sixth iteration, two bottom vertical luma edges from the third column (Y 32|33 and Y 42|43) are deblocked in parallel on clusters 0-1.

In the seventh iteration, two top vertical luma edges from the fourth column (Y 13|14 and Y 23|24) are deblocked in parallel on clusters 0-1.

In the eighth iteration, two bottom vertical luma edges from the fourth column (Y 33|34 and Y 43|44) are deblocked in parallel on clusters 0-1. This finishes the vertical luma edges.

In the ninth iteration, two left horizontal luma edges from the first row (Y 01-11 and Y 02-12) are deblocked in parallel on clusters 0-1.

In the tenth iteration, two right horizontal luma edges from the first row (Y 03-13 and Y 04-14) are deblocked in parallel on clusters 0-1.

In the eleventh iteration, two left horizontal luma edges from the second row (Y 11-21 and Y 12-22) are deblocked in parallel on clusters 0-1.

In the twelfth iteration, two right horizontal luma edges from the second row (Y 13-23 and Y 14-24) are deblocked in parallel on clusters 0-1.

In the thirteenth iteration, two left horizontal luma edges from the third row (Y 21-31 and Y 22-32) are deblocked in parallel on clusters 0-1.

In the fourteenth iteration, two right horizontal luma edges from the third row (Y 23-33 and Y 24-34) are deblocked in parallel on clusters 0-1.

In the fifteenth iteration, two left horizontal luma edges from the fourth row (Y 31-41 and Y 32-42) are deblocked in parallel on clusters 0-1.

In the sixteenth iteration, two right horizontal luma edges from the fourth row (Y 33-43 and Y 34-44) are deblocked in parallel on clusters 0-1. This finishes the horizontal luma edges.

In the seventeenth iteration, two vertical Cb chroma edges from the first column (Cb 10|11 and Cb 20|21) are deblocked in parallel on clusters 0-1.

In the eighteenth iteration, two vertical Cb chroma edges from the second column (Cb 11|12 and Cb 21|22) are deblocked in parallel on clusters 0-1. This finishes the vertical Cb chroma edges.

In the nineteenth iteration, two horizontal Cb chroma edges from the first row (Cb 01-11 and Cb 02-12) are deblocked in parallel on clusters 0-1.

In the twentieth iteration, two horizontal Cb chroma edges from the second row (Cb 11-21 and Cb 12-22) are deblocked in parallel on clusters 0-1. This finishes the horizontal Cb chroma edges.

In the twenty-first iteration, two vertical Cr chroma edges from the first column (Cr 10|11 and Cr 20|21) are deblocked in parallel on clusters 0-1.

In the twenty-second iteration, two vertical Cr chroma edges from the second column (Cr 11|12 and Cr 21|22) are deblocked in parallel on clusters 0-1. This finishes the vertical Cr chroma edges.

In the twenty-third iteration, two horizontal Cr chroma edges from the first row (Cr 01-11 and Cr 02-12) are deblocked in parallel on clusters 0-1.

In the twenty-fourth iteration, two horizontal Cr chroma edges from the second row (Cr 11-21 and Cr 12-22) are deblocked in parallel on clusters 0-1. This finishes the horizontal Cr chroma edges. The total number of iterations is 24.

Using our notation of edge, iteration and cluster sets, we have:
1. the first set of edges (vertical luma) is allocated on the set of clusters 0-1, and processed in the set of iterations 1-8, with full utilization;
2. the second set of edges (horizontal luma) is allocated on the set of clusters 0-1, and processed in the set of iterations 9-16, with full utilization;
3. the third set of edges (vertical Cb) is allocated on the set of clusters 0-1, and processed in the set of iterations 17-18, with full utilization;
4. the fourth set of edges (horizontal Cb) is allocated on the set of clusters 0-1, and processed in the set of iterations 19-20, with full utilization;
5. the fifth set of edges (vertical Cr) is allocated on the set of clusters 0-1, and processed in the set of iterations 21-22, with full utilization;
6. the sixth set of edges (horizontal Cr) is allocated on the set of clusters 0-1, and processed in the set of iterations 23-24, with full utilization.

Other allocations are possible as well, with the same efficiency (for example, the order of Cb and Cr processing can be exchanged).

### Parallelization in a Single Edge Deblocking Process by Mathematical Tensor Operations Applied on Pixel Values in Blocks

Though the H.264 standard defines the derivation process for the computation of all the filters in the filtering unit 500, it does not define the exact implementation of these mathematical operations. To do them on a sequential processor may require many sequential scalar operations, and thus be inefficient.

According to the teachings of the invention, it is novel to perform the edge deblocking process by expressing the filter in terms of mathematical tensor operations on two 4×4 blocks of pixels denoted by P and Q in FIGS. 13A and 13B, using any processor capable of doing such operations. In the following, we exemplify the operations assuming that such a processor is an AVIOR cluster.

FIGS. 13A and 13B depict the data used in the deblocking of a vertical edge 340 or a horizontal edge 341. Without loss of generality, we will present the teaching of this invention on the process of vertical edge deblocking, presented schematically in FIG. 300, though it similarly applies to horizontal edge deblocking, with appropriate transposition of the blocks.

In order to deblock vertical edge 340, each of the four rows of pixels (comprising a row of 4 pixels to the left of the edge 340 in the block 342 and a row of 4 pixels to the right of the edge 340 in the block 344) must be filtered. The filter output is computed as a weighted sum of the pixels in the rows. The actual filtering process and the weights are defined in the H.264 standard and depend on parameters computed separately. For each row of pixels, there are three possible outcomes: long filter result, short filter result and no filter at all.

According to the teachings of this invention, a generic edge filtering is performed using a process with data flow schematically represented in FIG. 7. All the possible outcomes for each row of pixels are computed, and then for each row, one of the outcomes is selected. Though the long and the short filters can operate in parallel, in the preferred embodiment on the AVIOR architecture, the computation of the long filter outputs (Pl, Ql) and short filter outputs (Ps, Qs) and the selectors are implemented on a single cluster as sequential operations.

Example of Luma Filter Implementation Using Tensor Operations The following is an example of vertical edge deblocking filter corresponding to boundary strength value of 4, as defined in the H.264 standard. The process goes as follows:

1. Compute the long filter result (two 4×4 blocks, Pl and Ql):

$$P 1 = [ P \cdot ( \begin{matrix}8 & 2 & 0 & 0 \\ 0 & 3 & 2 & 1 \\ 0 & 1 & 2 & 2 \\ 0 & 1 & 2 & 2\end{matrix} ) + Q \cdot ( \begin{matrix}0 & 1 & 2 & 2 \\ 0 & 0 & 0 & 1 \\ 0 & 0 & 0 & 0 \\ 0 & 0 & 0 & 0\end{matrix} ) + ( \begin{matrix}0 & 4 & 4 & 4 \\ 0 & 4 & 4 & 4 \\ 0 & 4 & 4 & 4 \\ 0 & 4 & 4 & 4\end{matrix} ) ] >> 3$$

$$Q 1 = [ P \cdot ( \begin{matrix}0 & 0 & 0 & 0 \\ 0 & 0 & 0 & 0 \\ 1 & 0 & 0 & 0 \\ 2 & 2 & 1 & 0\end{matrix} ) + Q \cdot ( \begin{matrix}2 & 2 & 1 & 0 \\ 2 & 2 & 1 & 0 \\ 1 & 2 & 3 & 0 \\ 0 & 0 & 2 & 8\end{matrix} ) + ( \begin{matrix}4 & 4 & 4 & 0 \\ 4 & 4 & 4 & 0 \\ 4 & 4 & 4 & 0 \\ 4 & 4 & 4 & 0\end{matrix} ) ] >> 3$$

In other words, the long filter output 4×4 matrix Pl is the P matrix in FIG. 13A times a weighting matrix W1, plus the Q matrix in FIG. 13B times a weighting matrix W2, plus a predetermined third matrix W3, with the overall result divided by integer 8 on an each element basis. The same is true for the long filter output 4×4 matrix Ql but the weighting matrices are different (Z1, Z2 and Z3 replace W1, W2 and W3 above). Here >>3 denotes arithmetic shift right by 3 (integer division by 8) and + is the addition operation, applied element-wise to a 4×4 matrix, as a SIMD operation, as follows:

$$\begin{matrix}A \text{>>} 3 = ( \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ) \text{>>} 3 \\ = ( \begin{matrix}{a}_{11} \text{>>} 3 & {a}_{12} \text{>>} 3 & {a}_{13} \text{>>} 3 & {a}_{14} \text{>>} 3 \\ {a}_{21} \text{>>} 3 & {a}_{22} \text{>>} 3 & {a}_{23} \text{>>} 3 & {a}_{24} \text{>>} 3 \\ {a}_{31} \text{>>} 3 & {a}_{32} \text{>>} 3 & {a}_{33} \text{>>} 3 & {a}_{34} \text{>>} 3 \\ {a}_{41} \text{>>} 3 & {a}_{42} \text{>>} 3 & {a}_{43} \text{>>} 3 & {a}_{44} \text{>>} 3\end{matrix} ) ,\end{matrix}$$

$$\begin{matrix}A + B = ( \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ) + ( \begin{matrix}{b}_{11} & {b}_{12} & {b}_{13} & {b}_{14} \\ {b}_{21} & {b}_{22} & {b}_{23} & {b}_{24} \\ {b}_{31} & {b}_{32} & {b}_{33} & {b}_{34} \\ {b}_{41} & {b}_{42} & {b}_{43} & {b}_{44}\end{matrix} ) \\ = ( \begin{matrix}{a}_{11} + {b}_{11} & {a}_{12} + {b}_{12} & {a}_{13} + {b}_{13} & {a}_{14} + {b}_{14} \\ {a}_{21} + {b}_{21} & {a}_{22} + {b}_{22} & {a}_{23} + {b}_{23} & {a}_{24} + {b}_{24} \\ {a}_{31} + {b}_{31} & {a}_{32} + {b}_{32} & {a}_{33} + {b}_{33} & {a}_{34} + {b}_{34} \\ {a}_{41} + {b}_{41} & {a}_{42} + {b}_{42} & {a}_{43} + {a}_{43} & {a}_{44} + {b}_{44}\end{matrix} ) \end{matrix}$$

On the AVIOR cluster, an element-wise operation on 4×4 matrix is carried out efficiently in a single instruction Tensor operation, that is, for example, 16 elements of a 4×4 matrix can be added to 16 elements of another 4×4 matrix as a single instruction.
The notation A B, where A and B are 4×4 matrices, is used to denote matrix multiplication, whose result is a 4×4 matrix, computed by adding up element-wise products of the rows of matrix A by the columns of matrix B, as follows:

$$A \cdot B = ( \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ) \cdot ( \begin{matrix}{b}_{11} & {b}_{12} & {b}_{13} & {b}_{14} \\ {b}_{21} & {b}_{22} & {b}_{23} & {b}_{24} \\ {b}_{31} & {b}_{32} & {b}_{33} & {b}_{34} \\ {b}_{41} & {b}_{42} & {b}_{43} & {b}_{44}\end{matrix} ) = ( \begin{matrix}{a}_{11} {b}_{11} + {a}_{12} {b}_{21} + {a}_{13} {b}_{31} + {a}_{14} {b}_{41} & {a}_{11} {b}_{12} + {a}_{12} {b}_{22} + {a}_{13} {b}_{32} + {a}_{14} {b}_{42} & {a}_{11} {b}_{13} + {a}_{12} {b}_{23} + {a}_{13} {b}_{33} + {a}_{14} {b}_{43} & {a}_{11} {b}_{14} + {a}_{12} {b}_{24} + {a}_{13} {b}_{34} + \\ {a}_{21} {b}_{11} + {a}_{22} {b}_{21} + {a}_{23} {b}_{31} + {a}_{24} {b}_{41} & {a}_{21} {b}_{12} + {a}_{22} {b}_{22} + {a}_{23} {b}_{32} + {a}_{24} {b}_{42} & {a}_{21} {b}_{13} + {a}_{22} {b}_{23} + {a}_{23} {b}_{33} + {a}_{24} {b}_{43} & {a}_{21} {b}_{14} + {a}_{22} {b}_{24} + {a}_{23} {b}_{34} + \\ {a}_{31} {b}_{11} + {a}_{32} {b}_{21} + {a}_{33} {b}_{31} + {a}_{34} {b}_{41} & {a}_{31} {b}_{12} + {a}_{32} {b}_{22} + {a}_{33} {b}_{32} + {a}_{34} {b}_{42} & {a}_{31} {b}_{13} + {a}_{32} {b}_{23} + {a}_{33} {b}_{33} + {a}_{34} {b}_{43} & {a}_{31} {b}_{14} + {a}_{32} {b}_{24} + {a}_{33} {b}_{34} + \\ {a}_{41} {b}_{11} + {a}_{42} {b}_{21} + {a}_{43} {b}_{31} + {a}_{44} {b}_{41} & {a}_{41} {b}_{12} + {a}_{42} {b}_{22} + {a}_{43} {b}_{32} + {a}_{44} {b}_{42} & {a}_{41} {b}_{13} + {a}_{42} {b}_{23} + {a}_{43} {b}_{33} + {a}_{44} {b}_{43} & {a}_{41} {b}_{14} + {a}_{42} {b}_{24} + {a}_{43} {b}_{34} +\end{matrix}$$

The computation results Pl and Ql (the long filtered blocks) are 4×4 blocks, in which each row is the result of the application of the long filter.

2. Compute the short filter result (two 4×4 blocks, Ps and Qs):

Ps=(p₃p₂p₁(2p₁+p₀+q₁+2)>>2)

Qs=((2q₁+q₀+p₁+2)>>2q₁q₂q₃)
Ps and Qs are 4×4 matrices formed of four 4×1 vectors, in which each row is the result of the application of the short filter. Here p₃, p₂, p₁, p₀ refer to the columns of the 4×4 block P in FIG. 13A, e.g.,

$${p}_{1} = ( \begin{matrix}{p}_{11} \\ {p}_{21} \\ {p}_{31} \\ {p}_{41}\end{matrix} )$$

and q₃,q₂,q₁,q₀ refer to the columns of the 4×4 block Q in FIG. 13A, e.g.,

$${q}_{1} = ( \begin{matrix}{q}_{11} \\ {q}_{21} \\ {q}_{31} \\ {q}_{41}\end{matrix} )$$

as shown in FIG. 13A.
The notation p+q refers to element-wise addition of 4×1 vectors p and q (columns of pixels 4×4 blocks); notation 2p implies element-wise multiplication of the 4×1 vector p by 2 and >>2 implies arithmetic right shift applied element-wise to the 4×1 vector, as follows:

$${p}_{1} \text{>>} 3 = ( \begin{matrix}{p}_{11} \\ {p}_{21} \\ {p}_{31} \\ {p}_{41}\end{matrix} ) \text{>>} 3 = ( \begin{matrix}{p}_{11} \text{>>} 3 \\ {p}_{21} \text{>>} 3 \\ {p}_{31} \text{>>} 3 \\ {p}_{41} \text{>>} 3\end{matrix} ) , \\ 2 {p}_{1} = 2 ( \begin{matrix}{p}_{11} \\ {p}_{21} \\ {p}_{31} \\ {p}_{41}\end{matrix} ) = ( \begin{matrix}2 {p}_{11} \\ 2 {p}_{21} \\ 2 {p}_{31} \\ 2 {p}_{41}\end{matrix} ) , \\ 2 {p}_{1} = 2 ( \begin{matrix}{p}_{11} \\ {p}_{21} \\ {p}_{31} \\ {p}_{41}\end{matrix} ) = ( \begin{matrix}2 {p}_{11} \\ 2 {p}_{21} \\ 2 {p}_{31} \\ 2 {p}_{41}\end{matrix} ) .$$

The computation results Ps and Qs are 4×4 blocks, in which each row is the result of the application of the short filter.

3. Compute the masking matrices, which represent the selection operations:

DELTA=|(p₀ p₀ p₀ p₀)−(q₀ q₀ q₀ q₀)|

C1=DELTA<α

C2=|(q₁ q₁ q₁ q₁)−(q₀ q₀ q₀ q₀)|<β

C3=|(p₁ p₁ p₁ p₁)−(p₀ p₀ p₀ p₀)|<β

M0=C1&C2&C3

C6=DELTA<(α>>2+2)

Mp=|(p₂ p₂ p₂ p₂)−(p₀ p₀ p₀ p₀)<β &C6

Mq=|(q₂ q₂ q₂ q₂)−(q₀ q₀ q₀ q₀)|<β & C6
Here α and β are scalar parameters computed separately, as defined in the H.264 standard. ∥ denotes absolute value applied element-wise to a 4×4 matrix as a SIMD operation, as follows:

[symbol]

$$\vert A \vert = \vert ( \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ) \vert = ( \begin{matrix}\vert {a}_{11} \vert & \vert {a}_{12} \vert & \vert {a}_{13} \vert & \vert {a}_{14} \vert \\ \vert {a}_{21} \vert & \vert {a}_{22} \vert & \vert {a}_{23} \vert & \vert {a}_{24} \vert \\ \vert {a}_{31} \vert & \vert {a}_{32} \vert & \vert {a}_{33} \vert & \vert {a}_{34} \vert \\ \vert {a}_{41} \vert & \vert {a}_{42} \vert & \vert {a}_{43} \vert & \vert {a}_{44} \vert\end{matrix} )$$

< denotes comparison operation, applied element-wise to a 4×4 matrix as a SIMD operation and resulting in a binary matrix, in which, each element equals [symbol] if the conditions holds and equal 0 otherwise, For example,

$$( \begin{matrix}- 3 & - 2 & 0 & - 1 \\ 1 & 11 & 0 & 2 \\ 2 & - 10 & 0 & 4 \\ 6 & 1 & 1 & 0\end{matrix} ) < 0 = ( \begin{matrix}1 & 1 & 0 & 0 \\ 0 & 0 & 0 & 0 \\ 0 & 1 & 0 & 0 \\ 0 & 0 & 0 & 0\end{matrix} )$$

& denotes logical AND operation, applied element-wise to a binary 4×4 matrix (i.e., matrix whose elements are either 1 or 0) as a SIMD operation. For example,

$$( \begin{matrix}0 & 0 & 0 & 0 \\ 0 & 0 & 0 & 0 \\ 1 & 0 & 0 & 0 \\ 1 & 1 & 1 & 0\end{matrix} ) \& ( \begin{matrix}0 & 1 & 0 & 0 \\ 0 & 0 & 0 & 1 \\ 1 & 0 & 0 & 0 \\ 1 & 0 & 1 & 0\end{matrix} ) = ( \begin{matrix}0 & 0 & 0 & 0 \\ 0 & 0 & 0 & 0 \\ 1 & 0 & 0 & 0 \\ 1 & 0 & 1 & 0\end{matrix} ) .$$

The matrices M0, Mp and mq are 4×4 matrices with binary rows (i.e., containing rows equal to either 1 or 0) and are used as a mathematical representation of the selector 604 in FIG. 7. In mask M0, the value of 0 in a row implies that no filter should be applied for this row in blocks P and Q. In mask Mp, the value of 0 in a row implies that the long filter should be applied for this row in block P. In mask Mq, the value of 0 in a row implies that the long filter should be applied for this row in block Q.

4. combine the long and short filtered results using the masks:

Pf=M0&(Mp&Pl+(!Mp)&Ps)+(!M0)&P

Qf=M0&(Mq&Ql+(!Mq)&Qs)+(!M0)&Q
Here ! denotes logical NOT operation, applied element-wise to a 4×4 binary matrix as a SIMD operation. For example,

[symbol]

$$( \begin{matrix}0 & 0 & 0 & 0 \\ 0 & 0 & 0 & 0 \\ 1 & 0 & 0 & 0 \\ 1 & 1 & 1 & 0\end{matrix} ) != ( \begin{matrix}1 & 1 & 1 & 1 \\ 1 & 1 & 1 & 1 \\ 0 & 1 & 1 & 1 \\ 0 & 0 & 0 & 1\end{matrix} ) .$$

The result of this computation are the 4×4 matrices Pf and Qf, containing the filtered blocks of pixels around the edge. This completes the edge deblocking filtering process.

Other filtering processes according to the H.264 standard are implemented in a similar manner.

Although the invention has been disclosed in terms of the preferred and alternative embodiments disclosed herein, those skilled in the art will appreciate other alternative embodiments which do not depart from the ideas expressed herein. All such alternatives embodiments are intended to be included within the scope of the claims appended hereto.

What is claimed:

1. A process for carrying out the deblocking filter defined by the H.264 video coding standard, operating by simultaneously deblocking edges in a luma macroblock and Cb and Cr chroma macroblocks, wherein an edge is a boundary between two blocks, and vertical edge filtering refers to changing the pixels in the blocks on the left and the right of the edge, and horizontal edge filtering refers to changing the pixels in the blocks above and below the edge, using a parallel processing architecture computer having a plurality of computational units (hereafter called clusters);
wherein the vertical luma edges form the first set of edges, the horizontal luma edges form the second set of edges, the vertical Cb chroma edges form the third set of edges, the horizontal Cb chroma edges form the fourth set of edges, the vertical Cr chroma edges form the fifth set of edges, the horizontal Cb chroma edges form the sixth set of edges; and
wherein the processing of each set of edges is carried on a plurality of computational units referred to as a set of clusters, in a set of iterations determined by the data dependency within the set of edges and with other sets of edges, such that the first set of edges is processed on the first set of clusters in the first set of iterations, and so on for the rest of the sets of edges, mutatis mutandis; and
wherein said sets of clusters and sets of iterations may be partially or completely overlapping or completely disjoint, wherein overlap of the sets of iterations implies simultaneous processing of parts or entire sets of edges, and overlap of the sets of clusters implies that processing of different parts of sets of edges is allocated to the same computational units.

2. The process of claim 1 wherein each cluster is itself a parallel processing unit capable of performing operations simultaneously on luma or chroma block data elements.

3. The process of claim 2 wherein the operations are tensor operations, which refers to any mathematical arithmetic or logical operation applied to a matrix on element-wise, column-wise or row-wise basis, and tensor is a general term referring to matrices or vectors.

4. The process of claim 1 wherein maximum parallel processing of all sets of said edges is performed to achieve maximum simultaneous deblocking in the fewest number of iterations such that
during a first set of one or more iterations, all vertical luma and all vertical chroma edges defined by a predetermined first set of columns are simultaneously deblocked, and
during a second set of iterations, all vertical luma and all vertical chroma edges defined by a predetermined second set of columns are simultaneously deblocked, and
during a third set of iterations, all vertical luma edges defined by a predetermined third set of columns and a predetermined first set of horizontal luma edges defined by a predetermined first set of rows are simultaneously deblocked, and
during a fourth set of iterations, all vertical luma edges defined by a predetermined fourth set of columns and a predetermined second set of horizontal luma edges defined by a predetermined second set of rows are simultaneously deblocked, and
during a fifth set of iterations, all horizontal chroma edges defined by a predetermined first set of rows of said Cb and Cr chroma macroblocks and a predetermined set of horizontal luma edges defined by a predetermined set of rows of said luma macroblock are simultaneously deblocked, and
during a sixth set of iterations, all horizontal chroma edges defined by a predetermined second set of rows of said Cb and Cr chroma macroblocks and a predetermined set of horizontal luma edges defined by a predetermined set of rows of said luma macroblock are simultaneously deblocked, and
during a seventh set of iterations, a predetermined set of horizontal luma edges defined by a predetermined set of rows of said luma macroblock and data dependency and luma edges previous deblocked are simultaneously deblocked, and [symbol]
during an eighth set of iterations, a predetermined set of horizontal luma edges defined by a predetermined set of rows of said luma macroblock and data dependency and luma edges previous deblocked are simultaneously deblocked to complete the deblocking process,
and wherein simultaneous means all specified edges are deblocked in one or more iterations but preferably one iteration but more than one iteration can be used if there are idle clusters during some iterations and data dependency allows the use of more than one iteration to deblock the specified set of edges, and wherein sets of columns and sets of rows means the columns and rows of luma and Cb and Cr macroblocks defined by data dependency so as to achieve full deblocking of all luma and chroma edges in the fewest number of iterations.

5. The process of claim 1 wherein said luma macroblock has a left neighbor macroblock of the same size and an upper neighbor macroblock of the same size, and wherein said parallel architecture computer has four clusters, all of which are used to simultaneously deblock said luma data in the following sequence:
the vertical edges between the column of 4 blocks in the left neighbor macroblock and the first and leftmost column of 4 blocks in the current macroblock in a first iteration, wherein each of the four edge filtering processes is carried out independently by each cluster;
the vertical edges between the first and the second columns of 4 blocks in the current macroblock in a second iteration, wherein each of the four edge filtering processes is carried out independently by each cluster;
the vertical edges between the second and the third columns of 4 blocks in the current macroblock in a third iteration, wherein each of the four edge filtering processes is carried out independently by each cluster;
the vertical edges between the third and the fourth columns of 4 blocks in the current macroblock in a fourth iteration, wherein each of the four edge filtering processes is carried out independently by each cluster;
and, the same process applied to horizontal edges, as follows: A
the horizontal edges between the row of 4 blocks in the upper neighbor macroblock and the first and topmost column of 4 blocks in the current macroblock in a fifth iteration, wherein each of the four edge filtering processes is carried out independently by each cluster;
the horizontal edges between the first and the second rows of 4 blocks in the current macroblock in a sixth iteration, wherein each of the four edge filtering processes is carried out independently by each cluster;
the horizontal edges between the second and the third rows of 4 blocks in the current macroblock in a seventh iteration, wherein each of the four edge filtering processes is carried out independently by each cluster;
the horizontal edges between the third and the fourth rows of 4 blocks in the current macroblock in a eighth iteration, wherein each of the four edge filtering processes is carried out independently by each cluster.

6. The process of claim 1 wherein said luma macroblock has a left neighbor macroblock of the same size and an upper neighbor macroblock of the same size, and wherein said parallel architecture computer has two clusters, all of which are used to simultaneously deblock said luma data in the following sequence:
the 2 vertical edges between the upper half of column of blocks in the left neighbor macroblock and the upper half of the first and leftmost column of blocks in the current macroblock in a first iteration, wherein each of the two edge filtering processes is carried out independently by each cluster;
the 2 vertical edges between the lower half of column of blocks in the left neighbor macroblock and the lower half of the first and leftmost column of blocks in the current macroblock in a second iteration, wherein each of the two edge filtering processes is carried out independently by each cluster;
the 2 vertical edges between the upper half of the first column of blocks and the upper half of the second column of blocks in the current macroblock in a third iteration, wherein each of the two edge filtering processes is carried out independently by each cluster;
the 2 vertical edges between the lower half of the first column of blocks and the lower half of the second column of blocks in the current macroblock in a fourth iteration, wherein each of the two edge filtering processes is carried out independently by each cluster,
the 2 vertical edges between the upper half of the second column of blocks and the upper half of the third column of blocks in the current macroblock in a fifth iteration, wherein each of the two edge filtering processes is carried out independently by each cluster,
the 2 vertical edges between the lower half of the second column of blocks and the lower half of the third column of blocks in the current macroblock in a sixth iteration, wherein each of the two edge filtering processes is carried out independently by each cluster;
the 2 vertical edges between the upper half of the third column of blocks and the upper half of the fourth column of blocks in the current macroblock in a seventh iteration, wherein each of the two edge filtering processes is carried out independently by each cluster;
the 2 vertical edges between the lower half of the third column of blocks and the lower half of the fourth column of blocks in the current macroblock in a eighth iteration, wherein each of the two edge filtering processes is carried out independently by each cluster,
and, the same process applied to horizontal edges, as follows:
the 2 horizontal edges between the left half of row of blocks in the upper neighbor macroblock and the left half of the first and topmost row of blocks in the current macroblock in a ninth iteration, wherein each of the two edge filtering processes is carried out independently by each cluster,
the 2 horizontal edges between the right half of row of blocks in the upper neighbor macroblock and the right half of the first and topmost row of blocks in the current macroblock in a tenth iteration, wherein each of the two edge filtering processes is carried out independently by each cluster;
the 2 horizontal edges between the left half of the first row of blocks and the left half of the second row of blocks in the current macroblock in an eleventh iteration, wherein each of the two edge filtering processes is carried out independently by each cluster;
the 2 horizontal edges between the right half of the first row of blocks and the right half of the second row of blocks in the current macroblock in an twelfth iteration, wherein each of the two edge filtering processes is carried out independently by each cluster;
the 2 horizontal edges between the left half of the second row of blocks and the left half of the third row of blocks in the current macroblock in an thirteenth iteration, wherein each of the two edge filtering processes is carried out independently by each cluster;
the 2 horizontal edges between the right half of the second row of blocks and the right half of the third row of blocks in the current macroblock in an fourteenth iteration, wherein each of the two edge filtering processes is carried out independently by each cluster;
the 2 horizontal edges between the left half of the third row of blocks and the left half of the fourth row of blocks in the current macroblock in an fifteenth iteration, wherein each of the two edge filtering processes is carried out independently by each cluster;
the 2 horizontal edges between the right half of the third row of blocks and the right half of the fourth row of blocks in the current macroblock in an sixteenth iteration, wherein each of the two edge filtering processes is carried out independently by each cluster.

7. The process of claim 1 wherein said luma macroblock has a left neighbor macroblock of the same size and an upper neighbor macroblock of the same size, and wherein said parallel architecture computer has eight clusters, all of which are used to simultaneously deblock said luma data in the following sequence:
A) a first set of four of said clusters are used to simultaneously deblock the 4 vertical luma edges between column of 4 blocks in the left neighbor macroblock and the first and leftmost column of 4 blocks in the current macroblock in a first iteration;
B) the same first set of four of said clusters as were used in step A are used in a second iteration to simultaneously deblock the vertical luma edges between the first column of blocks and the second column of blocks;
C) the same first set of four of said clusters as were used in step A are used in a second iteration to simultaneously deblock the vertical luma edges between the second column of blocks and the third column of blocks; and
one cluster in the second set of the remaining four clusters is used to deblock the first, leftmost horizontal luma edge between row of 4 blocks in the upper neighbor macroblock and the first topmost row of the current macroblock during said third iteration; and
D) two cluster of the same first set of four of said clusters as were used in step A are used in a fourth iteration to simultaneously deblock the vertical luma edges between the third column of blocks and the fourth column of blocks; and
two clusters in the same second set of the remaining four clusters as were used in step C are used to simultaneously deblock:
the first, leftmost horizontal luma edge between the first row of 4 blocks and the second row of 4 blocks; and
the second from left horizontal luma edge between row of 4 blocks in the upper neighbor macroblock and the first topmost row of the current macroblock, during said fourth iteration; and
E) the same second set of the remaining four clusters as were used in step C are used to simultaneously deblock:
the first, leftmost horizontal luma edge between the second row of 4 blocks and the third row of 4 blocks; and
the second from left horizontal luma edge between the fisrt row of 4 blocks and the second row of 4 blocks; and
the third from left horizontal luma edge between row of 4 blocks in the upper neighbor macroblock and the first topmost row of the current macroblock,
the fourth from left horizontal luma edge between row of 4 blocks in the upper neighbor macroblock and the first topmost row of the current macroblock, during said fifth iteration; and
F) the same second set of the remaining four clusters as were used in step C are used to simultaneously deblock:
the first, leftmost horizontal luma edge between the third row of 4 blocks and the fourth row of 4 blocks; and
the second from left horizontal luma edge between the second row of 4 blocks and the third row of 4 blocks; and
the third from left horizontal luma edge between the edge between the first row of 4 blocks and the second row of 4 blocks; and
the fourth from left horizontal luma edge between the first row of 4 blocks and the second row of 4 blocks;
during a sixth iteration; and
G) three of the same second set of the remaining four clusters as were used in step C are used to simultaneously deblock:
the second from left horizontal luma edge between the third row of 4 blocks and the fourth row of 4 blocks; and
the third from left horizontal luma edge between the second row of 4 blocks and the third row of 4 blocks; and
the fourth from left horizontal luma edge between the second row of 4 blocks and the third row of 4 blocks;
during a seventh iteration; and
H) two of the same second set of the remaining four clusters as were used in step C are used to simultaneously deblock:
the third from left horizontal luma edge between the third row of 4 blocks and the fourth row of 4 blocks; and
the fourth from left horizontal luma edge between the third row of 4 blocks and the fourth row of 4 blocks during an eighth iteration.

8. The process of claim 7 wherein the chroma (Cb and Cr) data is simultaneously deblocked with the luma data as follows: [symbol]
I) using the same said second set of the remaining four clusters as was used in step C to simultaneously deblock during said first iteration:
the vertical edges of 2 blocks in the first column of the Cb chroma macroblock; and
the vertical edges of 2 blocks in the first column of the Cr chroma macroblock;
J) using the same said second set of the remaining four clusters as was used in step C to simultaneously deblock during said second iteration:
the vertical edges of 2 blocks in the second column next on the right to said first column of the Cb chroma macroblock; and
the vertical edges of 2 blocks in the second column next on the right to said first column of the Cr chroma macroblock;
K) using the same said first set of four clusters as were used in step A to simultaneously deblock during said fifth iteration:
the horizontal edges of 2 blocks in the first topmost row of the Cb chroma macroblock; and
the horizontal edges of 2 blocks in the first topmost row of the Cr chroma macroblock;
L) using the same said first set of four clusters as were used in step A to simultaneously deblock during said sixth iteration:
the horizontal edges of 2 blocks in the second row next below said first row of the Cb chroma macroblock; and
the horizontal edges of 2 blocks in the second row next below said first row of the Cr chroma macroblock.

9. A process for deblocking in a parallel architecture computer, comprising the steps:
A) determining data independent calculations in the deblocking process for the vertical edges of a macroblock in a first column of blocks of said macroblock;
B) loading blocks of pixels needed for at least some of the data independent calculations determined in step A into clusters of a parallel architecture computer, wherein the number blocks than can be processed on each iteration is bounded by the number of available clusters and the data dependency;
C) simultaneously calculating deblocking of said blocks in all clusters loaded in step B and storing said filtered pixel values;
D) repeating steps A through D in multiple iterations until all vertical edges in all columns of a macroblock have been deblocked;
E) if any clusters of said parallel architecture are unused during said iterations of deblocking of said vertical edges, determining ripeness of horizontal edges for deblocking by determining if any horizontal edge or edges in said macroblock can be deblocked because final values for pixels in the blocks that define said horizontal edge have been deblocked for the last time during deblocking of said macroblock, and if it is determined that one or more horizontal edges of said macroblock are ripe for deblocking, loading the blocks needed to deblock said horizontal edge or edges into unused clusters and deblocking said horizontal edge or edges simultaneously with deblocking of said vertical edges; and
F) continuing to use clusters of said parallel architecture computer in a plurality of iterations to deblock filter horizontal edges of said macroblock as said blocks have their pixel values finally adjusted during the process of deblocking said vertical edges and continuing said iterations until all said horizontal edges have been deblocked.

10. A computer-readable medium having stored therein computer-readable instructions which, when executed by a computer, cause said computer to carry out the following process:
A) determining data independent calculations in the deblocking process for the vertical edges of a macroblock in a first column of blocks of said macroblock;
B) loading blocks of pixels needed for at least some of the data independent calculations determined in step A into clusters of a parallel architecture computer, [symbol] wherein the number blocks than can be processed on each [symbol] number of available clusters and the data dependency;
C) simultaneously calculating deblocking of said blocks in all clusters loaded in step B and storing said filtered pixel values;
D) repeating steps A through D in multiple iterations until all vertical edges in all columns of a macroblock have been deblocked;
E) if any clusters of said parallel architecture are unused during said iterations of deblocking of said vertical edges, determining ripeness of horizontal edges for deblocking by determining if any horizontal edge or edges in said macroblock can be deblocked because final values for pixels in the blocks that define said horizontal edge have been deblocked for the last time during deblocking of said macroblock, and if it is determined that one or more horizontal edges of said macroblock are ripe for deblocking, loading the blocks needed to deblock said horizontal edge or edges into unused clusters and deblocking said horizontal edge or edges simultaneously with deblocking of said vertical edges; and
F) continuing to use clusters of said parallel architecture computer in a plurality of iterations to deblock filter horizontal edges of said macroblock as said blocks have their pixel values finally adjusted during the process of deblocking said vertical edges and continuing said iterations until said horizontal edges have been deblocked.

11. A computer programmed to preform deblocking of horizontal and vertical edges of a luma macroblock, said computer having a plurality of calculation clusters, comprising:
first means for deblocking all the vertical edges in a luma macroblock in multiple iterations using a plurality of computing clusters of a parallel architecture computer, said means for deblocking the columns of vertical of a edges in the order determined by their data dependencies with at least some of the data independence vertical edges in each iteration being simultaneously deblocked using multiple ones of said clusters operated simultaneously; and [symbol]
second means for deblocking all the horizontal edges in a luma macroblock in multiple iterations using a plurality of computing clusters of a parallel architecture computer, said second means for deblocking the columns of horizontal edges in the order determined by their data dependencies with at least some of the data independent vertical edges in each iteration being simultaneously deblocked using multiple ones of said clusters operated simultaneously.

12. The apparatus of claim 11 further comprising means for using clusters that are unused during certain iterations to deblock luma pixel edges to deblock all vertical and horizontal chroma pixel edges in chroma macroblocks associated with said luma macroblock.

13. A process to calculate filtered pixel values to deblock an edge, using a computer capable of performing mathematical tensor operations to perform column-wise, row-wise and element-wise multiplication of 4×4 matrices, wherein one or more matrices of weights defined in the H.264 video coding standard is multiplied by one or more matrices of luma or chroma pixel values of a first block and a second block which define an edge between them which is to be deblocked, and the matrix multiplication results are combined so as to derive the deblocking filter output for said first and second blocks.

14. The process of claim 13 wherein the two blocks containing the pixels across the edge to be deblocked (either vertically or horizontally) are referred to as 4×4 matrices P and Q, respectively, the filtered blocks are denoted by P′ and Q′, respectively, and the computation of the deblocking filter output for said blocks is performed as follows:
1) computation of the long filter output for block P, described by the mathematical formula
Pl=P·W1+Q·W2+W3 [symbol]
wherein multiplication is understood as matrix multiplication and W1, W2 and W3 are constant matrices, derived from the H.264 video coding standard specifications;
2) computation of the short filter output for the block P, described by the mathematical formula
Ps=(p₃p₂p₁(2p₁+p₀+q₁+2)>>2)
3) computation of the long filter output for block Q, described by the mathematical formula
Ql=P·Z1+Q·Z2+Z3
wherein multiplication is understood as matrix multiplication and Z1, Z2 and Z3 are constant matrices, derived from the H.264 video coding standard specifications;
4) computation of the short filter output for the block Q, described by the mathematical formula
Qs=((2q₁+q₀+p₁+2)>>2q₁q₂q₃)
5) computation of a binary row- or column-wise 4×4 mask matrix Mp, deciding for each row or column of P, whether the long or the short filter should be operated on it, according to the specifications of the H.264 video coding standard, wherein the value of 1 in a row corresponds to the long filter and the value of 0 corresponds to the short filter.
6) computation of a binary row- or column-wise 4×4 mask matrix Mq, deciding for each row or column of Q, whether the long or the short filter should be operated on it, according to the specifications of the H.264 video coding standard, wherein the value of 1 in a row corresponds to the long filter and the value of 0 corresponds to the short filter.
7) computation of a binary row-wise 4×4 mask matrix M0, deciding for each row of P and Q whether it should be filtered, according to the specifications of the H.264 video coding standard, wherein the value of 1 in a row corresponds to operating the filter and the value of 0 corresponds to not operating the filter.
8) combining the long and short filtered results using the masks:
Pf=M0&(Mp&Pl+(!Mp)&Ps)+(!M0)&P
Qf=M0&(Mq&Ql+(!Mq)&Qs)+(!M0)&Q
where ! denotes logical NOT operation, applied element-wise to a 4×4 binary matrix as a SIMD operation.

[symbol]

15. The process of claim 14, wherein all the [symbol] performed in integer arithmetic, including the operation [symbol] by powers of 2 carried out using arithmetic shift.

16. A process for deblocking an edge defined by two 4×4 blocks of pixels comprising:
performing a long filtering process and a short filtering process on each row of pixels defined by said two 4×4 blocks;
for each row of a deblocked 4×4 output block corresponding to each of said two 4×4 blocks of pixels which are input to the deblocking process, selecting either the results calculated by said long filter or the results calculated by said short filter or the original pixel data of the row based upon predetermined selection criteria.

17. The process of claim 16 wherein each long filtering process and each short filtering process is carried out in a hardwired circuit.

18. The process of claim 16 wherein each long filtering process and each short filtering process is carried out in a software process.

19. The process of claim 16 wherein each long filtering process and each short filtering process is carried out as a tensor operation in a computational unit of a parallel processing computer wherein said computation unit is capable of processing 4×4 matrix data and processes all four rows of pixel data simultaneously in each of said long filter and short filter processes.

[symbol]

20. The process of claim 16 wherein said long filter processes are carried out simultaneously.

21. An apparatus comprising:
first means for simultaneously deblocking a first plurality of vertical luma edges and a first plurality of Cb and Cr chroma edges in a first two iterations, all edges being deblocked in the order required by data dependency;
second means for simultaneously deblocking a second plurality of luma vertical edges and a first plurality of horizontal luma edges during third and fourth iterations, all edges being deblocked in the order required by data dependency;
third means for simultaneously deblocking a first plurality of Cb and Cr chroma horizontal edges and second plurality of horizontal luma edges during fifth and sixth iterations, all said edges being deblocked in the order required by data dependency;
fourth means for simultaneously deblocking a third plurality of horizontal luma edges during seventh and eighth iterations, all edges being deblocked in the order required by data dependency.

22. A process comprising:
simultaneously deblocking a first plurality of vertical luma edges and a first plurality of Cb and Cr chroma edges in a first two iterations, all edges being deblocked in the order required by data dependency;
simultaneously deblocking a second plurality of luma vertical edges and a first plurality of horizontal luma edges during third and fourth iterations, all edges being deblocked in the order required by data dependency;
simultaneously deblocking a first plurality of Cb and Cr chroma horizontal edges and second plurality of horizontal luma edges during fifth and sixth iterations, all said edges being deblocked in the order required by data dependency; [symbol]
simultaneously deblocking a third plurality of horizontal luma edges during seventh and eighth iterations, all edges being deblocked in the order required by data dependency.

23. A computer-readable medium having stored thereon computer-readable instructions which, when executed by one or more computational units causes said one or more computational units to perform the following process:
simultaneously deblocking a first plurality of vertical luma edges and a first plurality of Cb and Cr chroma edges in a first two iterations, all edges being deblocked in the order required by data dependency;
simultaneously deblocking a second plurality of luma vertical edges and a first plurality of horizontal luma edges during third and fourth iterations, all edges being deblocked in the order required by data dependency;
simultaneously deblocking a first plurality of Cb and Cr chroma horizontal edges and second plurality of horizontal luma edges during fifth and sixth iterations, all said edges being deblocked in the order required by data dependency;
simultaneously deblocking a third plurality of horizontal luma edges during seventh and eighth iterations, all edges being deblocked in the order required by data dependency.

24. An apparatus for deblocking an edge defined by a left block of pixels and a right block of pixels comprising:
means for doing the long filter and short filter deblocking calculations simultaneously to deblock a left block of pixels; and
means for doing the long filter and short filter deblocking calculations simultaneously to deblock a right block of pixels.

[symbol]

25. The apparatus of claim 24 wherein each of [symbol] programmed computational unit of a parallel processing computer capable of performance tensor operations on matrix data such that all rows of each of said left and right [symbol] pixels are deblocked simultaneously as the deblocking result for each of said left and right blocks of pixels is calculated.

26. The apparatus of claim 25 wherein each of said means includes means to select the long filter result, the short filter result or not filtering at all for each row of said left or right block of pixels being deblocked.

27. A process for deblocking an edge defined by left and right blocks of pixels comprising the steps:
A) doing long filter and short filter deblocking calculations simultaneously to deblock a left block of pixels; and
B) doing long filter and short filter deblocking calculations simultaneously to deblock a right block or pixels.

28. The process of claim 27 wherein steps A and B each comprise performing tensor operations on matrix data such that all rows of each of said left and right blocks of pixels are deblocked simultaneously as the deblocking result for each of said left and right blocks of pixels is calculated.

29. The process of claim 28 wherein steps A and B each comprise selecting the long filter result, the short filter result or no filtering at all for each row of said left or right block of pixels being deblocked.

[symbol]

30. A deblocking process carried out on a parallel architecture computer comprising of a plurality of clusters, which are capable of operating simultaneously and independently of each other, wherein the deblocking process has three levels of parallelization, comprising simultaneously processing multiple edges of luma and/or chroma data defined by different blocks of the luma and/or chroma pixel data during predetermined iterations, with the number of edges being simultaneously processed and whether the edges are luma, chroma or both and whether the edges are horizontal or vertical determined by the number of clusters in said parallel architecture computer and by the inherent data dependency.

31. A deblocking process carried out in eight iterations on a parallel architecture computer comprising of eight clusters, each of which is capable of operating simultaneously and independently of each other, wherein the deblocking has multiple levels of parallelization in that both horizontal and vertical edges are processed simultaneously during some iterations, both luma and chroma edges are processed simultaneously during some iterations and wherein multiple rows of pixels in each block are processed simultaneously, wherein said deblocking process comprises:
A) simultaneously processing multiple edges of luma and/or chroma data defined by different blocks of the luma and/or chroma pixel data during predetermined iterations, with the number of edges being simultaneously processed during any particular iteration and whether the edges are luma, chroma or both during any particular iteration and whether the edges are horizontal or vertical during any particular iteration is determined by the number of clusters in said parallel architecture computer and by the inherent data dependency;
B) and wherein the horizontal and vertical luma and chroma edges are divided into 6 predetermined sets and wherein deblocking of set of edges 1 is carried out during iterations 1 through 4, the deblocking of set of edges 2 is carried out in iterations 3 through 8, the deblocking of set of edges 3 is carried out in iterations 1 and 2, the deblocking of set of edges 4 is carried out in iterations 5 and 6, the deblocking of set of edges 5 is carried out in iterations 1 and 2, and the [symbol] deblocking of set of edges 6 is carried out in iterations 5 and 6, wherein when the iterations numbers of the various sets of edges overlap, it means the edges are being simultaneously deblocked.

32. A computer-readable medium having stored thereon computer-readable instructions which, when executed by a parallel processing computer having a plurality of computational units called clusters, cause said parallel processing computer to perform the following deblocking process to deblock all the vertical and horizontal luma and chroma edges of a macroblock in eight iterations, said process comprising:
1) simultaneously deblocking a predetermined plurality of vertical luma edges and multiple vertical Cb and Cr chroma edges on all eight clusters during a first two of eight iterations; and
2) simultaneously deblocking a plurality of luma vertical edges and one luma horizontal edge during a third iteration using five of said plurality of clusters;
3) simultaneously deblocking a plurality of luma vertical edges and two luma horizontal edges during a fourth iteration using six of said clusters;
4) simultaneously deblocking a plurality of Cb and Cr chroma horizontal edges and a plurality of luma horizontal edges during a fifth and sixth iteration using all eight clusters;
5) simultaneously deblocking a plurality of horizontal luma edges during a seventh iteration using three clusters; and
6) simultaneously deblocking a plurality of horizontal luma edges during an eighth iteration using two clusters;
and wherein the order of deblocking of luma and chroma vertical and horizontal edges is determined by data dependency.

33. A process for simultaneously deblocking luma and chroma macroblocks over a plurality iterations using a parallel processing computer which has a plurality of computational units such that some are idle during some of said iterations, each [symbol] computational unit optimized for tensor operations on matrix data, each computational unit called a cluster, said process deblocking a luma macroblock and Cb and Cr macroblocks simultaneously during a plurality of iterations, said process comprising the steps:
1) simultaneously deblocking a first set vertical luma edges and a first set of vertical Cb and Cr chroma edges on a first set of clusters during a first set of said plurality of iterations; and
2) simultaneously deblocking a second set of vertical luma edges and a first set of one or more luma horizontal edge during a second set of one or more iterations using a second set of said plurality clusters; 3) simultaneously deblocking a first set of Cb and Cr horizontal chroma edges and a second set of horizontal luma edges during a third set iteration using third set of said clusters;
4) simultaneously deblocking a third set of horizontal luma edges during a fourth set of iterations using a fourth set of clusters;
and wherein the order of deblocking of luma and chroma vertical and horizontal edges is determined by data dependency.

34. A parallel processing architecture computer having a plurality of computational units called clusters, said computer programmed to perform the following process to deblock luma and chroma macroblocks of a video frame simultaneously over a plurality of iterations using a plurality of said clusters:
1) simultaneously deblocking a first set vertical luma edges and a first set of vertical Cb and Cr chroma edges on a first set of clusters during a first set of said plurality of iterations; and
2) simultaneously deblocking a second set of vertical luma edges and a first set of one or more luma horizontal edge during a second set of one or more iterations using a second set of said plurality clusters; [symbol]
3) simultaneously deblocking a first set Cb and Cr horizontal chroma edges and a second set of horizontal luma edges during a third set iteration using third set of said clusters;
4) simultaneously deblocking a third set of horizontal luma edges during a fourth set of iterations using a fourth set of clusters;
and wherein the order of deblocking of luma and chroma vertical and horizontal edges is determined by data dependency.

35. A computer-readable medium having stored thereon computer-readable instructions which when executed by a parallel processing architecture computer having a plurality of computational units called clusters cause said clusters to perform the following process to deblock luma and chroma macroblocks of a video frame simultaneously over a plurality of iterations using a plurality of said clusters:
1) simultaneously deblocking a first set vertical luma edges and a first set of vertical Cb and Cr chroma edges on a first set of clusters during a first set of said plurality of iterations; and
2) simultaneously deblocking a second set of vertical luma edges and a first set of one or more luma horizontal edge during a second set of one or more iterations using a second set of said plurality clusters;
3) simultaneously deblocking a first set of Cb and Cr horizontal chroma edges and a second set of horizontal luma edges during a third set iteration using third set of said clusters;
4) simultaneously deblocking a third set of horizontal luma edges during a fourth set of iterations using a fourth set of clusters;
and wherein the order of deblocking of luma and chroma vertical and horizontal edges is determined by data dependency.

36. An apparatus comprising: [symbol]
first means for simultaneously deblocking a first set of vertical luma edges and a first set of vertical Cb and Cr chroma edges over a first set of iterations using a first set of clusters of a parallel processing architecture computer;
second means for simultaneously deblocking a second set of vertical luma edges and a first set of horizontal luma edges over a second set of iterations using a second set of clusters;
third means for simultaneously deblocking a first set of Cb and Cr horizontal chroma edges and a second set of horizontal luma edges over a third set of iterations using a third set of said clusters;
fourth means for simultaneously deblocking a third set of horizontal luma edges over a fourth set of iterations using a fourth set of clusters;
and wherein said first, second, third and fourth means are structured to deblock said vertical and horizontal luma and chroma edges in an order determined by data dependency.

37. A process to calculate filtered pixel values to deblock an edge, using a computer capable of performing mathematical tensor operations to perform column-wise, row-wise and element-wise multiplication of 4×4 matrices, wherein one or more matrices of weights defined in the H.264 video coding standard is multiplied by one or more matrices of luma or chroma pixel values of a first block and a second block which define an edge between them which is to be deblocked, and the matrix multiplication results are combined so as to derive the deblocking filter output for said first and second blocks.

38. A parallel processing computer having a plurality of computing clusters, and programmed to perform deblocking of vertical and horizontal edges of luma and/or chroma macroblocks, said program controlling said computer to perform the following process: [symbol]
using one or more clusters of a parallel processing computer capable of performing matrix mathematical operations to multiply one or more matrices of weights defined in the H.264 video coding standard by on or more matrices of pixel values of a first block and a second block which define an edge between them which is to be deblocked, and to combine the matrix multiplication results so as to derive the deblocking filter output for said and second blocks.
